(19) United States
(12) Patent Application Publication
(10) Pub. No.: US 2003/0216961 A1
(43) Pub. Date: Nov. 20, 2003

(54) Personalized gaming and demographic collection method and apparatus

(76) Inventor: Douglas Barry, Tiburon, CA (US)

Correspondence Address: GLENN PATENT GROUP, 3475 EDISON WAY, SUITE L, MENLO PARK, CA, 94025, US

(21) Appl. No.: 10/147,635

(22) Filed: May 16, 2002

Related U.S. Application Data
(63) Continuation-in-part of application No. 10/089,973, filed on Feb. 26, 2003.

(51) Int. Cl. G06F 17/60

(52) U.S. Cl. 705/14; 705/10

(57) ABSTRACT

A method and apparatus that collects demographics from contestants using ubiquitous Internet devices or a new slot machine on a casino floor. Contestants are given the opportunity to earn points that they can redeem for various prizes that are of interest to them. A plurality of prizes can be selected from a plurality of categories. As the contestants play games of chance, a pool of advertisements is presented to the contestants. Advertisements from the pool are selected in accordance with each contestants buying propensity. As contestants play games of chance, the system infers additional propensities of each user and stores this for later reduction. The reduced data is then sold as marketing data together with a list of system users that comprises name, address, phone number and e-mail addresses and the like. The system is implemented using a client-server paradigm. A server maintains databases needed to track all of the contestants that register with the system. The client devices, including the new slot machine, use a standard web browser as a means to retrieve and display web pages to the contestant. Most web pages have an attached java-script program that implements the functionality of the present invention. Other web pages that contestants encounter comprise a shell for a Java applet that embodies a game of chance. The Java applet that implement games of chance are universal in distribution relying on the web browser to homogenize the user interface across a wide range of hardware platforms. The ubiquitous Internet devices and slot machine are connected to the games either through a wired or wireless network.

### CROSS-REFERENCE TO RELATED APPLICATIONS

This application is a Continuation-in-Part of U.S. Ser. No. 10/089,973 filed Apr. 3, 2002.

### BACKGROUND OF THE INVENTION

1. Technical Field

This invention pertains to the field of gambling apparatus and methods and to the field of demographics collection and dissemination.

2. Description of the Prior Art

Throughout recorded history, humankind has always been fascinated with the notion of winning great gains by wagering their belongings. The fundamental notion of winning money has remained unchanged over the millennia. In this country's early history, the gaming business turned to technology as a source of improved gaming methods and apparatus; all in an effort to further entice customers to drop their coins in the “one-armed bandit”.

Computer technology has really fueled modern gaming trends. Casinos throughout the nation, as well as throughout the world, were quick to embrace gaming machines based on new technology enabled by microprocessors. In the prior art, microprocessors really gave the slot machines a new look. Gone are the mechanical tumblers and spinning cylinders. Slot machines now included a wide array of exciting new display technologies, such as color cathode ray tubes (CRTs) and liquid crystal displays (LCDs). These provide visually stimulating and attractive interfaces that draw potential gamblers.

Gaming systems are now no longer limited to the casino environment. In fact, through the use of wide area computer networks, anybody that can use a web browser and understands the basic precepts of a graphical user interface can interact with a remote gaming system. In the prior art, there has been a significant proliferation of Internet based gaming systems that resemble casino style games-of-chance. Early gaming web sites allowed computer users to play just about any wagering game imaginable. Barring local statutes and ordinances to the contrary, gaming web sites also let computer users wager real money just like Las Vegas.

Whether in the traditional gambling parlor, or on a gambling web-site presented over the Internet, the prior art of gaming apparatus had several distinct limitations. First, the prior art microprocessor based slot machine could not adapt to a specific user in order to capitalize on that user's specific spending tendencies. Another drawback that all prior art gaming apparatus exhibit is that these prior art devices presume that all contestants are interested in winning money. Money may in fact not be the principal motivator for all gamblers. Traditional gambling houses have long recognized the fact that other prizes and promotions are needed to cater to the more sophisticated mentality of the present day gambler. As a result, many casinos now place specialized gaming machines on the casino floor. These allow gamblers to win other prizes such as cars or vacations.

Failing to recognize the captivity of their gambling audience, prior art gaming systems did not consider other profit mechanisms that could be employed as gamblers sit in front of slot machines. Because the contestants are, in essence, a captive audience, prior art gaming systems could have displayed other information to the contestant such as advertisements or interesting announcements. Casinos could realize an additional source of revenue by selling advertising opportunities to sponsoring advertisers.

Yet another shortcoming of prior art gaming machines is that they could not profile their users. By allowing users to fill out questionnaires, a gaming system could be tailored to a specific user in order to maintain a high level of interest in the gaming experience. Of course, by maintaining interest in the game gamblers are apt to play longer resulting in greater revenues for the casino. This secondary level of interaction with a gaming user can also be a source of demographic data. Demographics collected during a gaming session could also be sold to third parties as marketing data.

### SUMMARY OF THE INVENTION

The present invention comprises a method and apparatus that allows targets advertisements to a user based on demographics that the user exhibits. Generally, personal information about the user is received from number of sources and then store in a database. Presenting advertisements occurs contemporaneously with game play. In the present embodiment, each game integrates the advertisements in such manner as to make the playing experience more enjoyable. As a user plays the game, the present invention correlates personal attributes for the user with advertisements that are also stored in a database.

The present invention further comprises a method and apparatus that can target advertisement based on observations the system makes with respect to the users activities. Specifically, as a user plays a game, the user can select prizes that are of interest and can spend points in order to improve the probability that a prize will be awarded. Inferences can be drawn from these activities that result in a propensity profile for the user. These propensity profiles can also be used to target advertisements to specific users.

Advertisements are presented in a number of forms including, but not limited to simple graphical images, animated graphics, audio and video clips and even multimedia presentations. Each advertisement further comprises a hyperlink to an advertisers web site. This hyperlink, when activated, will retrieve additional information that the advertiser wants to convey. The additional information, usually incorporated into a web page, can also take of the forms that advertisements can take on, that being graphic images, animated graphics, video clips and multimedia presentations. This enumeration is intended to be illustrative and is not intended to limit the scope of the claims.

Another novel aspect of the present invention is that the games that are presented to users for play are themselves highly personalized to meet the tastes and preferences of the those users. Initially, the game can ask the user what prize they would like to vie for. These prizes are selected by the user and then incorporated directly into the game. The present invention further comprises a facility that tracks the game play a user exhibits and then modifies prize selection accordingly. Another mechanism that is used to personalize the games presented to the user is the ability to select prizes from a prize pool based on the users demographics.

In the general sense, selection of advertisements and prizes is based on the user's demographics or exhibited propensities and is done by selecting a category and then selecting an advertisement or prize from within that category. This, however, does not preclude those skilled in the art to recognize that the partitioning of the advertisement and prize pools can be done in any arbitrary manner that facilitates the correlation of user demographics or propensities to advertisements and/or prizes.

The present invention draws inferences with respect to the prizes a user prefers. The strength of the inference is bolstered by the fact that as a user plays to win a particular prize, that user can choose to buy down the odds of winning. The invention records each time a user attempts to win a prize based on random chance and also record each time the user chooses to pay for enhancing the win probability. This information then drives the propensities of the user that are subsequently used to target advertisements and select prizes.

The present invention maintains information relative to the cost of each prize offered to users. Together with information with respect to the income realized by presenting advertisements, the present invention adjusts the probability of a prize award to ensure that the prize is awarded no more frequently than the period in which an aggregate number of advertisements needed to pay for the prize are presented. This ensures that the system operator remains profitable. Once a prize is awarded, the present invention creates coupons that the user can print out and then use to redeem the prize.

The games are presented to the user through client devices such as, a personal computer, a set-top box, a ubiquitous Internet appliance and a slot machine. The client devices are connected to games through a wired or wireless network. The client devices contain a wireless network interface to communicate with personal electronic devices such as personal digital assistants and cellular phones. The personal electronic devices identify the user and conduct financial transactions.

### BRIEF DESCRIPTION OF THE DRAWINGS

The foregoing aspects are better understood from the following detailed description of one embodiment of the invention with reference to the drawings, in which:

FIG. 1 is a block diagram that depicts the system level interfaces to the adaptable gaming system;

FIG. 2 is a block diagram that depicts the connectivity of the PGS adaptable contest server and four types of user client devices;

FIG. 2A is a block diagram of a slot machine client device according to the present invention;

FIG. 2B is a pictorial of the slot machine and contestant identification devices used therewith;

FIG. 3 is a flow diagram that depicts the connectivity of web browser clients to a server software element;

FIG. 4 is a pictorial representation of a user database called user list;

FIG. 5 is a pictorial representation of a user database called supplemental information;

FIG. 6 is a pictorial representation of a user database called statistics;

FIG. 7 is a pictorial representation of a user database called propensities;

FIG. 8 is a pictorial representation of a user database called teams;

FIG. 9 is a pictorial representation of a user database called team-scores;

FIG. 10 is a pictorial representation of a user database called tax report;

FIG. 11 is a pictorial representation of an advertisement database called Advertisement Pool;

FIG. 12 is a pictorial representation of an advertisement database called Sponsor List;

FIG. 13 is a pictorial representation of an advertisement database called Prize Pool;

FIG. 14A is the first part of flow diagram that depicts the user interface process employed by the present invention;

FIG. 15 is a pictorial representation of a typical universal splash screen that is presented on the slot machine of the present invention;

FIG. 15A is a pictorial representation of a sign-in web page presented to an unknown user;

FIG. 15B is a pictorial representation of a sign-in web page presented to an existing user;

FIG. 15C is a pictorial representation of a User Validation web page that is presented to a contestant after a manual identification procedure;

FIG. 15D is a pictorial representation of a New Player Questionnaire web page;

FIG. 15E is a pictorial representation of a Program ID Device web page presented to a user after a new identification device is dispensed;

FIG. 16 is a pictorial representation of a personalized welcome page that is presented to a contestant using the system;

FIG. 17 is a pictorial representation of a team management GUI according to the present invention;

FIG. 18 is a pictorial representation of the games-to-play web page;

FIG. 19 is a pictorial representation of a gaming web page having at least one Java applet; and

FIG. 20 is a pictorial representation of the graphical user interface presented by the Prize Spin Java applet.

### DETAILED DESCRIPTION OF THE INVENTION

System Description

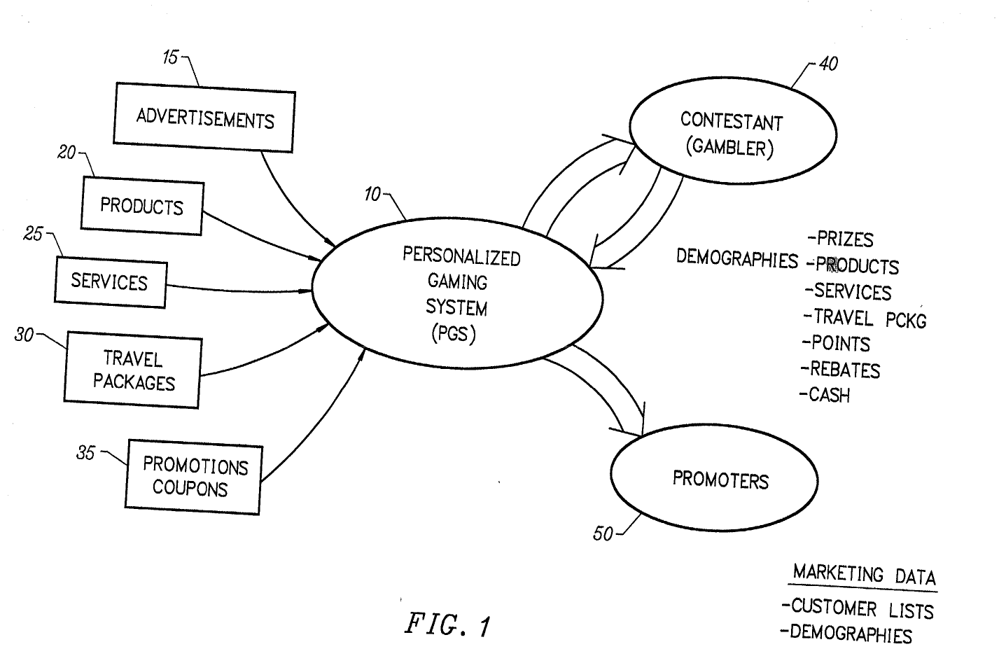

FIG. 1 is flow diagram that depicts the system level interfaces for a personalized gaming system according to the present invention. The personalized gaming system 10 (PGS) accepts a plurality of inputs. On the source side, the PGS accepts advertisements 15, products 20, services 25, travel packages 30, and product promotions 35. This list is not meant to limit the range or type of inputs that the PGS can accept, rather it is illustrative of the types of inputs that the present embodiment accepts. On the consumer side, the PGS delivers to contestants a wide range of prizes that are normally commensurate with the inputs the PGS receives. This means that prizes can include products, services, travel packages, and promotions. Also the contestant can aggregate his winnings through the accumulation of points and redeem these points for larger prizes. The contestant can also receive product rebates, coupons, and other product promotions. The contestants also serve as a source of demographic data. As an incentive, the contestants are rewarded with prizes whenever the contestants respond to marketing surveys and questionnaires needed to collect demographic data.

The PGS can also provides a plurality of products to promoters 50. Promoters can purchase marketing data in the form of customer lists, demographics, and etc. etc.

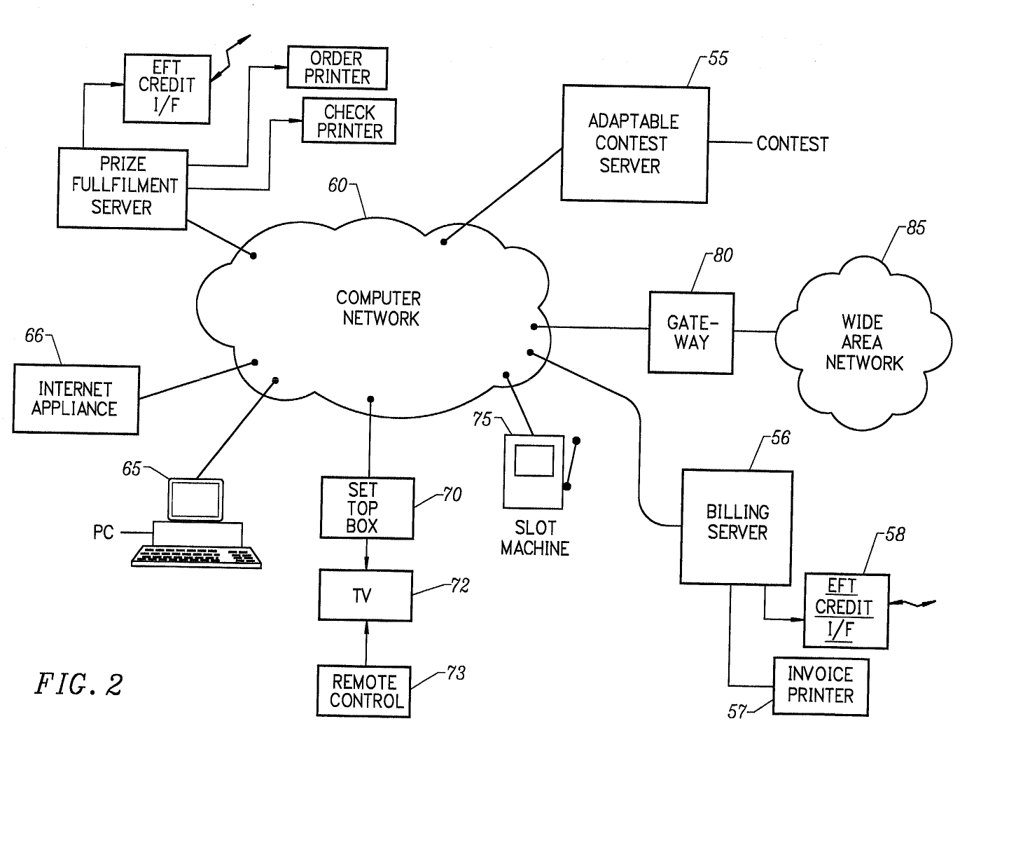

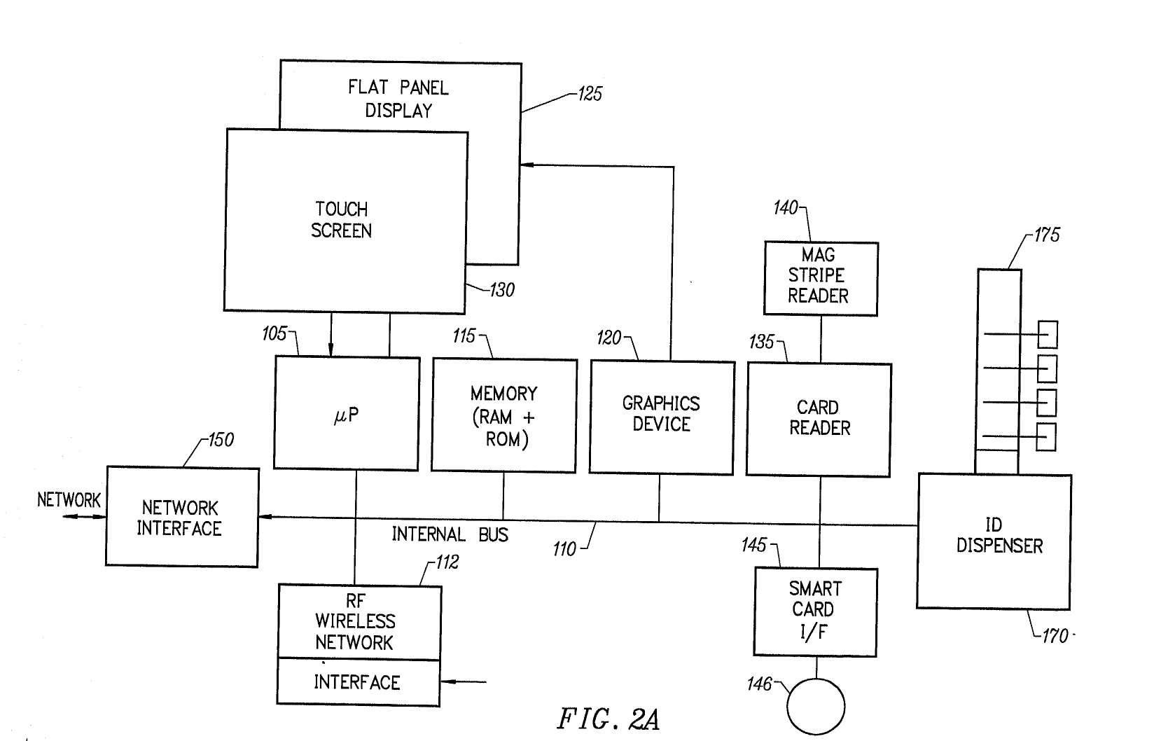

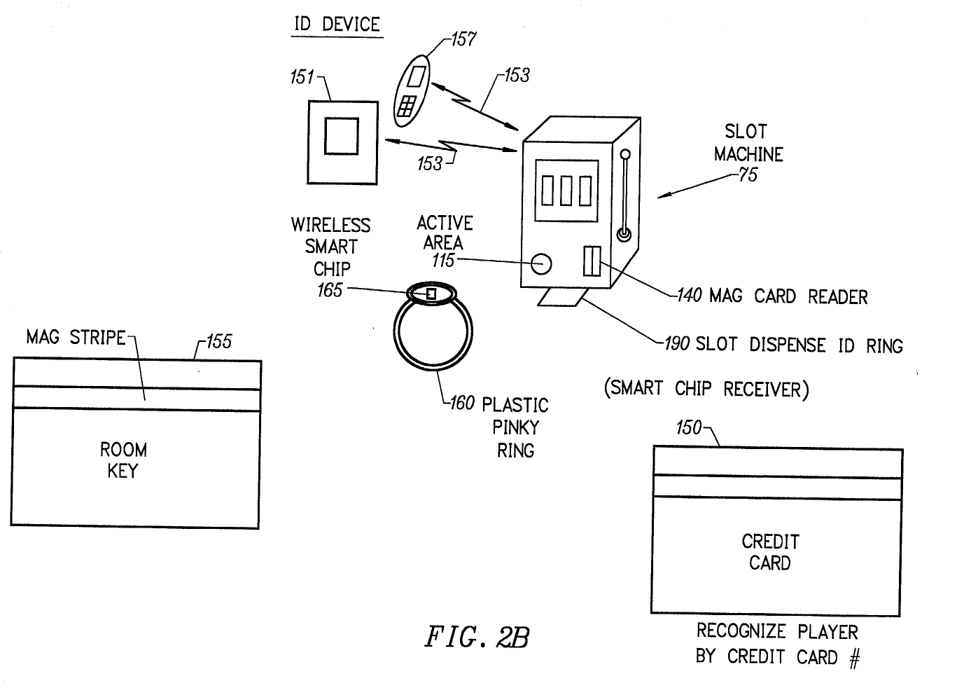

FIG. 2 is a block diagram that depicts the connectivity of the PGS adaptable contest server 55 (ACS) and four types of user client devices. In the current embodiment, the ACS 55 is connected to a computer network 60. Also connected to the computer network 60 are the user client devices. The four types of user client devices supported in the current embodiment include, but should not be construed as a limited to, a personal computer (PC) 65, a set-top box 70, a ubiquitous Internet appliance 66 and a slot machine 75. Also connected to the computer network 60 is a gateway 80. The gateway also serves as a firewall and enables external computers attached to a wide area network 85 to interact with the ACS 55 and the user client devices according to security privileges enforced by the firewall.

Client Devices

In the current embodiment, all of user client devices are substantially similar in architecture. Microprocessor based user client devices such as the PC 65, a set-top box 70, the Internet appliance 66 and the slot machine 75 all execute a web browser. The web browser executing in the user client devices interacts with the ACS 55 in order to retrieve web pages according to the present invention. The PC 65, the set top box 70 and the Internet appliance 66 are well known in the art. The slot machine 75 according to the present invention is new and novel.

FIG. 2A is a block diagram of a slot machine 75 client device according to the present invention. The slot machine 75 is, of course, microprocessor based. The microprocessor 105 interfaces to an internal bus 110. Using the internal bus 110, the microprocessor 105 retrieves instructions from a memory 115. The instructions stored in a memory 115 comprises a operating system and a web browser. The operating system manages the functional control of a graphics device 120. The graphics device 120 drives a graphic display 125. In the present embodiment, the graphics device display is a flat-panel display utilizing liquid crystal technology. In the present embodiment, flat-panel display is capable of color display at a resolution of 1024×768. Overlaying the flat-panel display is a touch screen 130. The touch screen 130 reports touch events to the microprocessor 105. By using a graphic display overlayed by a touch screen, the slot machine of the present invention can support a highly interactive graphical user interface with the contestant.

The microprocessor 105, as a result of executing instructions comprising the operating system, also controls a card reader 135. The card reader 135 senses activity occurring in a magnetic stripe card reader 140. As a contestant begins using the slot machine of the present invention, the contestant can “swipe” a magnetic stripe card through the magnetic stripe card reader 140. The operating system further comprises a driver for the card reader 135 that enables the slot machine to detect and read credit cards, special identification cards, hotel room keys and the like.

The slot machine of the present invention further comprises a network interface 150. The network interface 150 enables the slot machine of the present invention to communicate with a remote server such as the adaptable contest server 55. When necessary, the network interface can be used to communicate with a vast range of external devices connected either to the most proximate computer network 60 or any device connected to external networks by utilizing the gateway 80.

The slot machine of the present invention further comprises a smart card interface 145 and its associated active area 146. The smart card interface 145, again under control of a driver integral to the operating system, allows the slot machine 75 to detect and read a wireless identification device.

The slot machine 75 further comprises an identification element dispenser 170. The identification element dispenser 170 receives commands from the microprocessor 105 whenever the contestant needs a new identification element. In the present embodiment, the identification element is a plastic ring that comprises a wireless smart-card integrated circuit. The dispenser 170 receives plastic rings from a magazine 175. In the present embodiment, the dispenser 170 drops plastic rings through to a slot on the front of the slot machine 75. It should be noted that the identification device can be made in any convenient form that is not offensive to the contestant and promotes use of the device whenever the contestant uses the present slot machine.

FIG. 2B is a pictorial of the slot machine and contestant identification devices used therewith. In the present embodiment, the slot machine 75 further comprises the magnetic stripe card reader 140 and further comprises a smart card receiver 146. The magnetic stripe card reader 140 enables the slot machine 75 to read the magnetic stripe on a credit card 150 or a room key 155, such as those used in many hotels today, to identify a contestant using the slot machine. The slot machine 75 of the present invention can also use the information retrieved from a credit card 75 for financial purposes. These purposes can include charging the contestant for lost wagers or crediting the contestants credit card account to award cash winnings. The wireless smart card interface 145 includes active area 146. By using an identification element, such as a plastic pinky ring 160 that comprises a wireless smart chip 165, contestants can also be identified. The identification element dispenser 170 releases such plastic pinky rings to the contestant by way of a slot 180 on the front of the slot machine.

FIG. 2A shows one additional feature of the present embodiment. The slot machine of the present invention further comprises a wireless network interface 112. The wireless network interface 112 uses low-power radio-frequency communications to communicate with personal electronic devices such as personal digital assistants (PDA) and cell phone. The wireless network interface 112 incorporated into the present invention uses a frequency hopping scheme in conjunction with an encryption mechanism that supports secure transactions. The wireless network interface of the present invention conforms to the Bluetooth specification adopted by an industry consortium. It should be noted that any suitable wireless network interface can be utilized so long as secure transactions, wireless transactions with small personal devices can be accommodated.

FIG. 2B shows how the wireless network interface 112 can be used in conjunction with a PDA 151 or a cell phone 152. In actuality, any personal electronic device equipped with a wireless interface that is compatible with the wireless network interface incorporated into the slot machine of the present invention can be used. When a contestant first approaches the slot machine 75, the wireless network interface 112 establishes a connection 153 with the contestants personal device. This connection allows the slot machine 75 to identify the contestant and then effect any financial transactions the contestant authorizes.

Client-Server Architecture

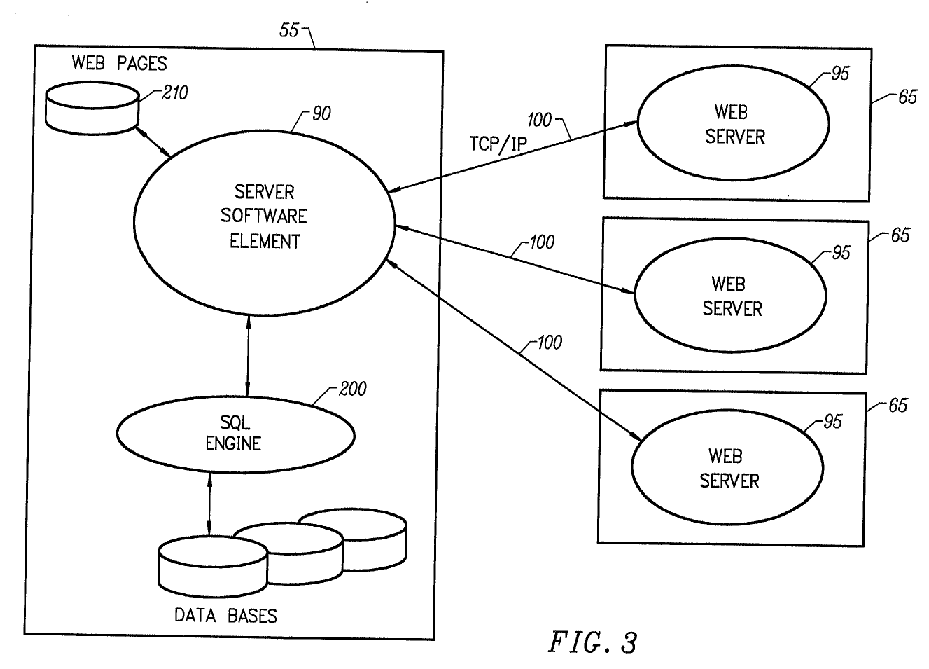

FIG. 3 is a flow diagram that depicts the connectivity of web browser clients to a server software element. The description provided here will assume that all of the user client devices are personal computers (PC) 65. It should be noted that the client-server interaction between the PC type user client devices and the other types of user client devices, i.e. the set-top box 70, Internet appliance 66 and the slot machine 75, are substantially similar. The only real variation in the user client devices is the means by which the web browser interacts with the specific hardware of the device type. This is discussed infra.

The ACS 55 executes a server software element 90. A plurality of user client devices, or PCs 65, execute web browsers 95. It should be noted that each instantiation of a web browser is peculiar to the user client devices and services one user. Each instantiation of a web browser 95 creates a dedicated TCP/IP 100 connection to the server software element 90 executing in the ACS 55. Other network protocols can also be used.

The ACS 55 further comprises a structured query language (SQL) engine 200. The SQL engine 200 manages a plurality of databases. These databases and the structure thereof are one key aspects of the present invention. The ACS 55 also further comprises a cache of web pages 210. The web page cache 210 is used to store a plurality of web pages. These web pages are delivered to the web browsers 95 as contestants use the invention.

Data Structures

The present invention comprises a plurality of databases. These include, but are not limited to databases that track contestants as users of the system (user databases); databases that track the products, services, and promotions that can be used as prizes that can be awarded to contestants (prize databases); and databases that are used to manage the display of advertising content to the system users (sponsor databases).

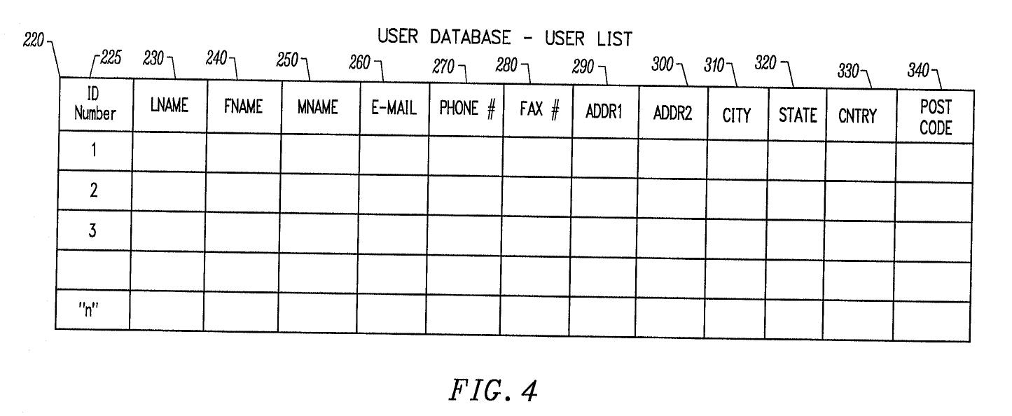

FIG. 4 is a pictorial representation of a user database called user list. The user list database 220 comprises a plurality of records each of which comprises a plurality of fields. The fields in the user list database comprise:

User Database-User List
(220)

| Field | | |
|---|---|---|
| Name | Reference | Usage Capacity |
| ID No. | 225 | The ID No. field is a key field and is |
| | | used to track a contestant registered |
| | | in the system. This field is used as a |
| | | relational index with other user |
| | | databases. |
| LNAME | 230 | The LNAME field is used to store the |
| | | last name of a contestant. |
| FNAME | 240 | The FNAME field is used to store the |
| | | first name of a contestant. |
| MNAME | 250 | The MNAME field is used to store the |
| | | middle name of a contestant. |
| EMAIL | 260 | The EMAIL field is used to store the |
| | | e-mail address of a contestant. |
| PHONE | 270 | The PHONE field is used to store the |
| | | phone number of a contestant. |
| FAX | 280 | The FAX field is used to store the |
| | | facsimile phone number of a |
| | | contestant. |
| ADDR1 | 290 | The ADDR1 field is used to store the |
| | | first line of a contestants mailing |
| | | address. |
| ADDR2 | 300 | The ADDR2 field is used to store the |
| | | second line of a contestants mailing |
| | | address. |
| CITY | 310 | The CITY field is used to store the |
| | | city for the contestants mailing |
| | | address. |
| STATE | 320 | The STATE field is used to store the |
| | | state for the contestants mailing |
| | | address. |
| CNTRY | 330 | The CNTRY field is used to store the |
| | | country for the contestants mailing |
| | | address. |
| POST- | 340 | The POST-CODE field is used to |
| CODE | | store a postal code for the |
| | | contestants mailing address. Where |
| | | the contestants mailing address is in |
| | | the United States of America, the |
| | | POST-CODE field is used to store |
| | | the zip code. |

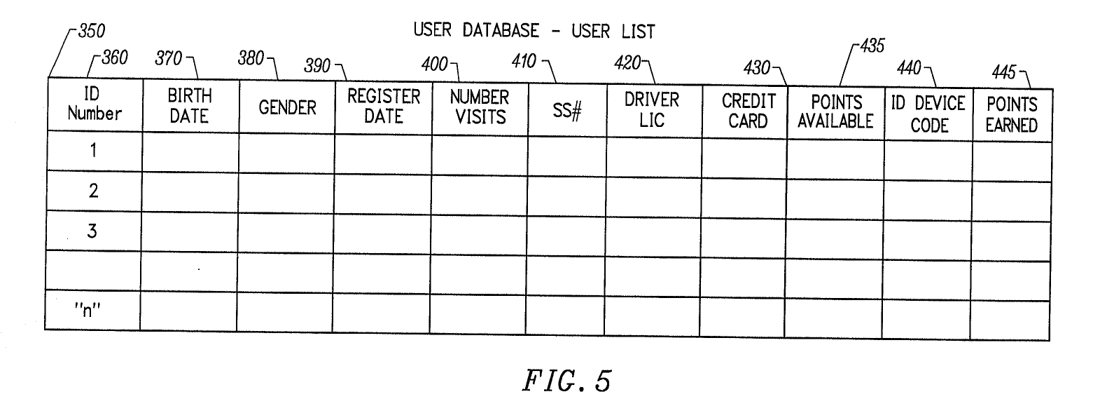

FIG. 5 is a pictorial representation of a user database called Supplemental Information. The supplemental information database 350 comprises a plurality of records each of which comprises a plurality of fields. The fields in the supplemental information database comprise:

User Database-Supplemental Information
(350)

| Field Name | Reference | Usage Capacity |
|---|---|---|
| ID No. | 360 | The ID No. field is a key field and |
| | | is used to track a contestant |
| | | registered in the system. This |
| | | field is used as a relational index |
| | | with other user databases. |
| BIRTH- | 370 | The BIRTH-DATE field is used to |
| DATE | | store the birth date of a |
| | | contestant. |
| GENDER | 380 | The GENDER field is used to |
| | | store the sex of a contestant. |
| REGISTER- | 390 | The REGISTER-DATE field is |
| DATE | | used to store the first name of a |
| | | contestant. |
| NUMBER- | 400 | The NUMBER-VISITS field is |
| VISITS | | used to track the number of times |
| | | a contestant uses the system. |
| SS# | 410 | The SS# field is used to store the |
| | | social security (or other tax |
| | | identification number) of a |
| | | contestant. |
| DRIVR- | 420 | The DRIVR-LIC field is used to |
| LIC | | store the drivers license number |
| | | of a contestant. |
| CREDIT- | 430 | The CREDIT-CARD field is used |
| CARD | | to store the credit card number of |
| | | a contestant. |
| POINTS | 435 | The POINTS AVAILABLE field is |
| AVAILABLE | | used to store the number of |
| | | points the contestant has. Points |
| | | can be accumulated either by |
| | | purchasing points, as with a |
| | | credit card, or by |
| ID DEVICE | 440 | The ID DEVICE field is used to |
| | | store the serial number of a |
| | | personal identification device. |
| POINTS | 445 | The POINTS EARNED field is |
| EARNED | | used to record the number of |
| | | points that the contestant has |
| | | accrued. |

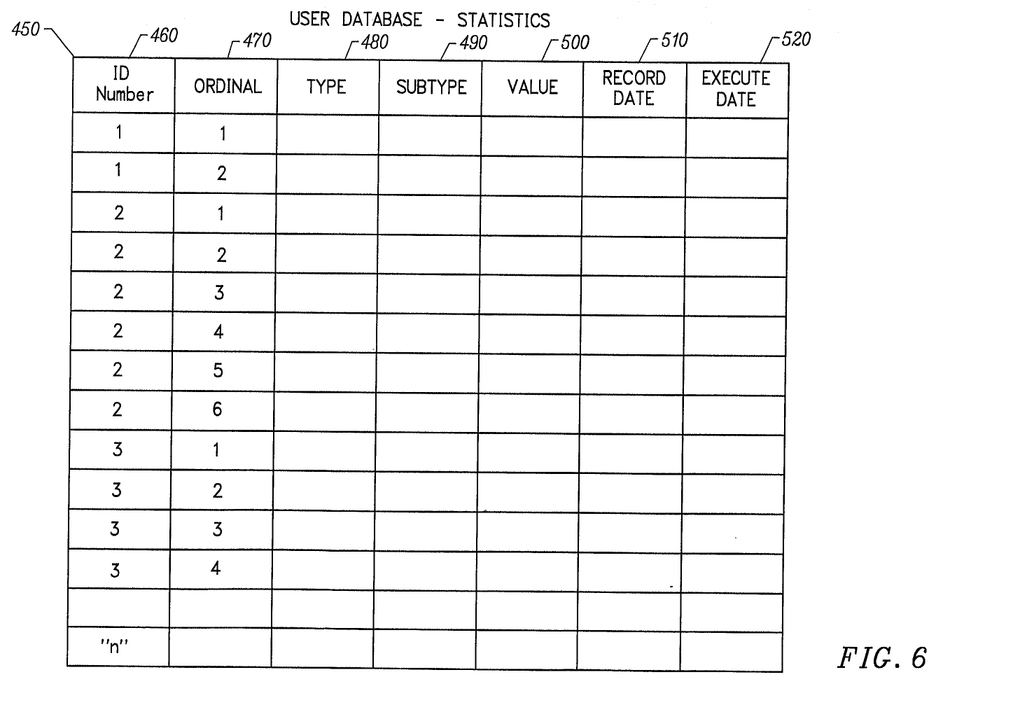

FIG. 6 is a pictorial representation of a user database called Statistics. The statistics database 450 comprises a plurality of records each of which comprises a plurality of fields. The fields in the statistics database comprise:

User Database-Statistics
(450)

| Field | | |
|---|---|---|
| Name | Reference | Usage Capacity |
| ID No. | 460 | The ID No. field is a key field and |
| | | is used to track a contestant |
| | | registered in the system. This field |
| | | is used as a relational index with |
| | | other user databases. |
| ORDINAL | 470 | The ORDINAL field is a key field |
| | | and is used to identify one of a |
| | | plurality of statistical records |
| | | afforded to a given user.. |
| TYPE | 480 | The TYPE field is used to store an |
| | | indicator of the type of statistics |
| | | record stored in that record. |
| SUBTYPE | 490 | The SUBTYPE field is used to |
| | | store a secondary classifying |
| | | indicator of the type of statistics |
| | | record stored in that record. |
| VALUE | 500 | The VALUE field is used to store a |
| | | statistical value in the record of the |
| | | given type and subtype. |
| RECORD- | 510 | The RECORD-DATE field is used |
| DATE | | to store the date on which the |
| | | record was first created. |
| EXECUTE- | 520 | The RECORD-DATE field is used |
| DATE | | to store the date on which the |
| | | action affiliated with the record |
| | | was closed. |

| Type | Subtype | Significance | Comment |
|---|---|---|---|
| 01 | | Total Minutes of Game Play- | |
| | | Slot Machine | |
| | 01 | Slot Machine- | |
| | | Configuration 01 | |
| | 02 | Slot Machine- | |
| | | Configuration 02 | |
| | 03 | Slot Machine- | |
| | | Configuration 03 | |
| | 04 | Slot Machine- | |
| | | Configuration 04 | |
| | 05 | Slot Machine- | |
| | | Configuration 05 | |
| 02 | | Total Minute of Game Play- | |
| | | Prize Category | |
| | 01 | Prize Category 01 | |
| | 02 | Prize Category 02 | |
| | 03 | Prize Category 03 | |
| | 04 | Prize Category 04 | |
| | 05 | Prize Category 05 | |
| 03 | | Prizes Claimed | |
| | 01 | Prize Code 01 | |
| | 02 | Prize Code 02 | |
| | 03 | Prize Code 03 | |
| | 04 | Prize Code 04 | |
| | 05 | Prize Code 05 | |

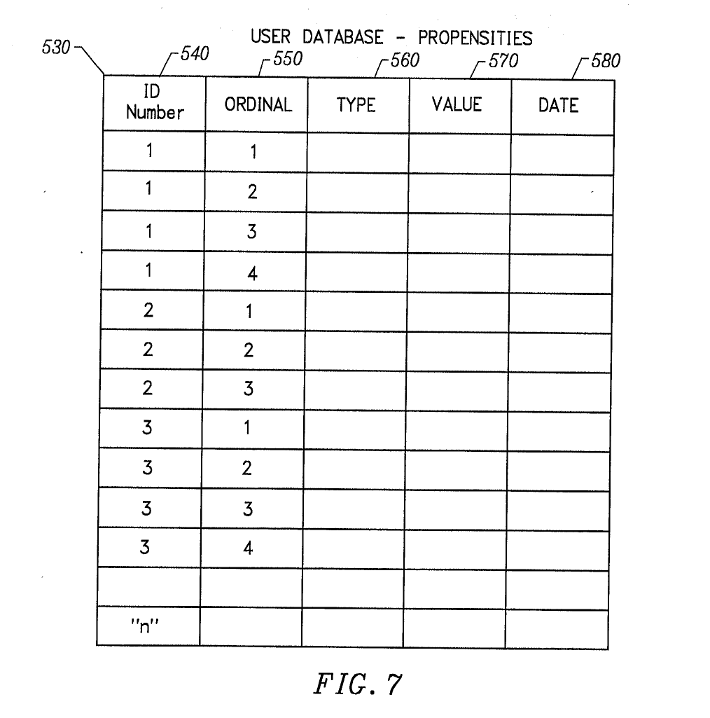

FIG. 7 is a pictorial representation of a user database called propensities. The propensities database 530 comprises a plurality of records each of which comprises a plurality of fields. The fields in the propensities database comprise:

User Database-Propensities
(530)

| Field | | |
|---|---|---|
| Name | Reference | Usage Capacity |
| ID No. | 540 | The ID No. field is a key field and is |
| | | used to track a contestant |
| | | registered in the system. This field |
| | | is used as a relational index with |
| | | other user databases. |
| ORDINAL | 550 | The ORDINAL field is a key field |
| | | and is used to identify one of a |
| | | plurality of propensity records |
| | | afforded to a given user.. |
| TYPE | 480 | The TYPE field is used to store an |
| | | indicator of the type of propensity |
| | | record stored in that record. |
| VALUE | 500 | The VALUE field is used to store a |
| | | statistical value in the record of the |
| | | given type of propensity. |
| DATE | 510 | The DATE field is used to store the |
| | | date on which the record was |
| | | created. |

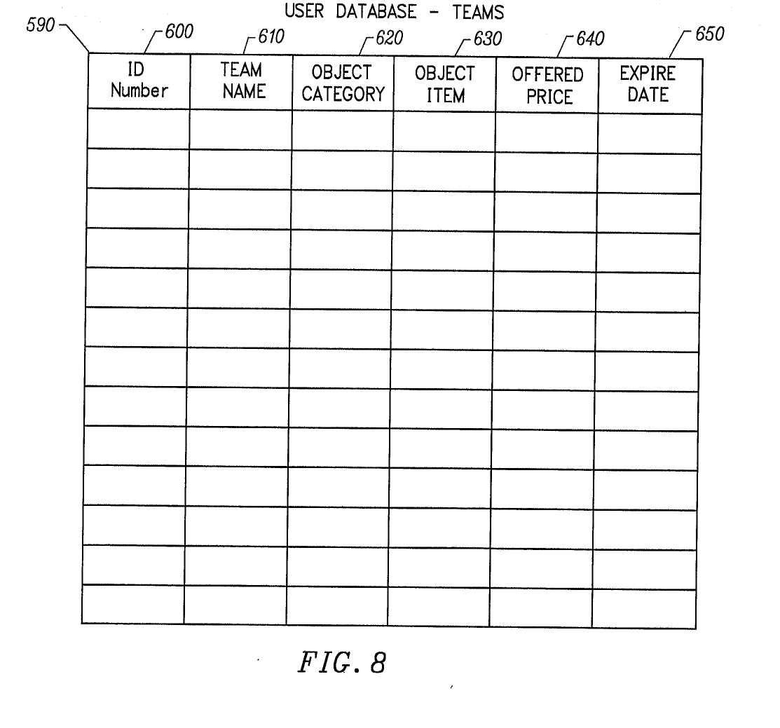

FIG. 8 is a pictorial representation of a user database called Teams. The teams database 590 comprises a plurality of records each of which comprises a plurality of fields. The fields in the teams database comprise:

User Database-Teams
(590)

| Field | | |
|---|---|---|
| Name | Reference | Usage Capacity |
| ID No. | 600 | The ID No. field is a key field and |
| | | is used to track a contestant |
| | | registered in the system. This field |
| | | is used as a relational index with |
| | | other user databases. |
| TEAM- | 610 | The TEAM-NAME field is a key |
| NAME | | field and is used to identify one of |
| | | a plurality of team description |
| | | records afforded to a given user. |
| OBJECT- | 620 | The OBJECT-CAT field is used to |
| CAT | | record the category of the prize |
| | | objective for the team of that |
| | | record. |
| OBJECT- | 630 | The OBJECT-ITEM field is used to |
| ITEM | | store the item number in the given |
| | | category of the prize objective for |
| | | the team of that record. |
| OFFERED- | 640 | The OFFERED-PRICE field is |
| PRICE | | used to store the number of |
| | | contestant points that are required |
| | | to win the prize. |
| EXPIRE- | 650 | The EXPIRE-DATE field is used to |
| DATE | | store the date on which the team |
| | | can no longer pool their points to |
| | | win the prize. |

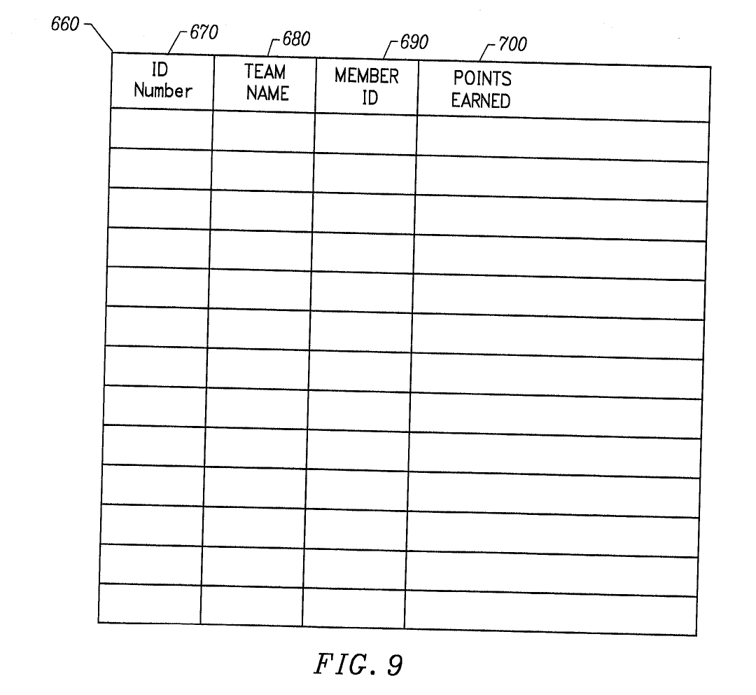

FIG. 9 is a pictorial representation of a user database called Team-Scores. The teams database 660 comprises a plurality of records each of which comprises a plurality of fields. The fields in the team scores database comprise:

User Database-Team-Scores
(660)

| Field | | |
|---|---|---|
| Name | Reference | Usage Capacity |
| ID No. | 670 | The ID No. field is a key field and is |
| | | used to track a contestant |
| | | registered in the system. This field |
| | | is used as a relational index with |
| | | other user databases. |
| TEAM- | 680 | The TEAM-NAME field is a key field |
| NAME | | and is used to identify one of a |
| | | plurality of team description records |
| | | afforded to a given user. |
| MEMBER | 690 | The MEMBER ID field is a key field |
| ID | | that is used to identify another |
| | | system user that is a member of the |
| | | team. |
| POINTS | 700 | The POINTS-EARNED field is used |
| EARNED | | to store the number of points |
| | | earned by the team member toward |
| | | the prize objective. |

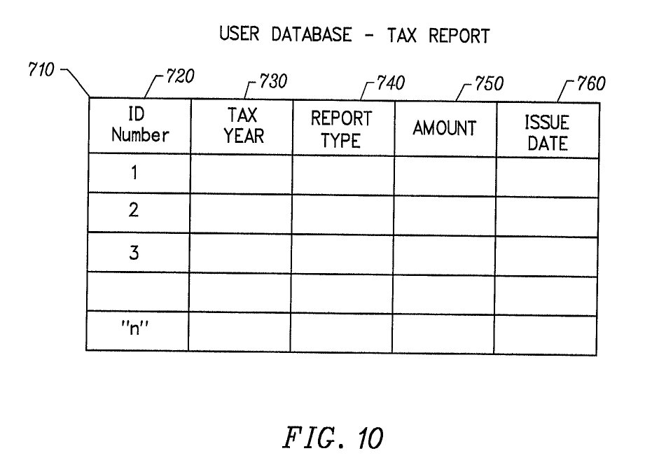

FIG. 10 is a pictorial representation of a user database called Tax Report. The tax report database 710 comprises a plurality of records each of which comprises a plurality of fields. The fields in the teams database comprise:

User Database-Team-Scores
(710)

| Field | | |
|---|---|---|
| Name | Reference | Usage Capacity |
| ID No. | 720 | The ID No. field is a key field and is |
| | | used to track a contestant |
| | | registered in the system. This field is |
| | | used as a relational index with other |
| | | user databases. |
| TAX | 730 | The TAX YEAR field is a key field |
| YEAR | | and is used to identify one of a |
| | | plurality of tax report records |
| | | afforded to a given user. |
| REPORT | 740 | The REPORT TYPE field is a key |
| TYPE | | field that that indicates the type of |
| | | tax report issued to a contestant. |
| AMOUNT | 750 | The AMOUNT field is used to store |
| | | cash value of winnings reported to |
| | | the tax authority. |
| ISSUE | 760 | The ISSUE DATE field is used to |
| DATE | | record the date on which the tax |
| | | report was issued to the tax |
| | | authority. |

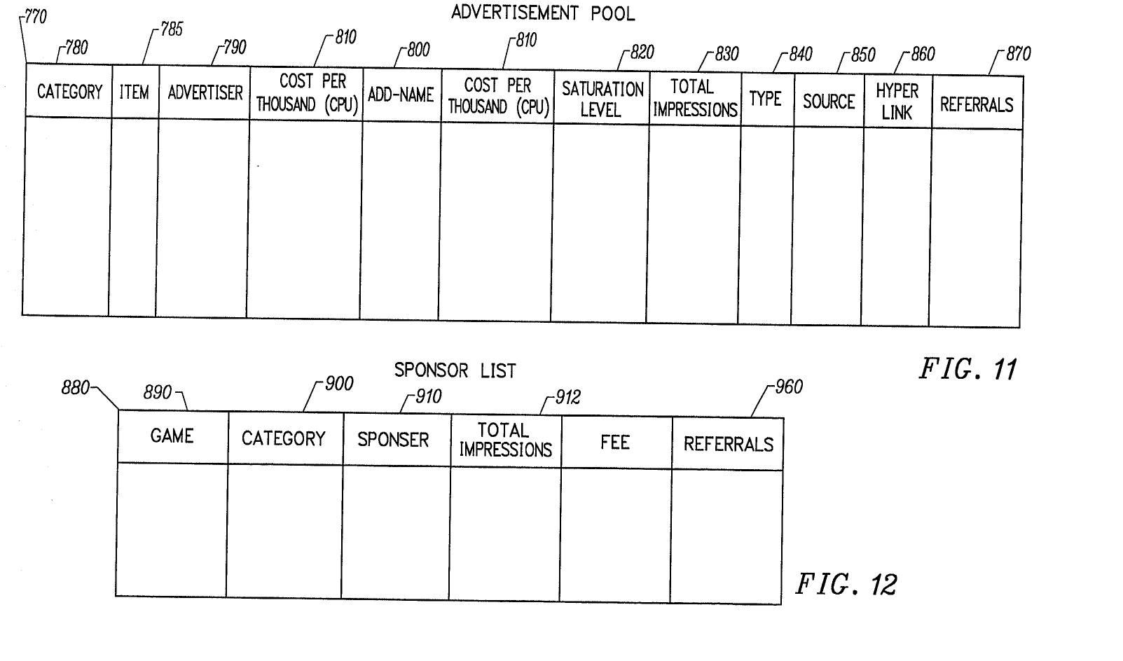

FIG. 11 is a pictorial representation of an advertisement database called Advertisement Pool. The advertisement pool database 770 comprises a plurality of records each of which comprises a plurality of fields. The fields in the advertisement pool database comprise:

User Database-Advertisement Pool
(770)

| Field Name | Reference | Usage Capacity |
|---|---|---|
| CATEGORY | 780 | The CATEGORY field is a key |
| | | field and is used to identify the |
| | | product category that the |
| | | advertisement belongs to. |
| ITEM | 785 | The ITEM field is a field that is |
| | | used to correlate an |
| | | advertisement to a prize. This |
| | | is used in calculating the odds |
| | | of winning prizes. |
| ADVERTISER | 790 | The ADVERTISER field is a |
| | | key field and is used to |
| | | identify one of a plurality of |
| | | advertisers that purchase |
| | | advertisement impressions on |
| | | the system. |
| AD NAME | 800 | The AD NAME field is a key |
| | | field and identifies the |
| | | advertisement. |
| COST PER | 810 | The COST PER THOUSAND |
| THOUSAND | | field is used to record the |
| (CPM) | | negotiated rate that is charged |
| | | to the advertiser for every one |
| | | thousand impression of the |
| | | advertisements made to |
| | | users. |
| SATURATION | 820 | The SATURATION field is |
| LEVEL | | used to record the preference |
| | | of the advertisement relative |
| | | to other advertisements that |
| | | will be presented to system |
| | | users. |
| TOTAL | 830 | The TOTAL IMPRESSIONS |
| IMPRESSIONS | | field is used to track the |
| | | number of impressions of the |
| | | advertiser made to |
| | | contestants: |
| TYPE | 840 | The TYPE field indicates the |
| | | media embodiment of the |
| | | advertisement. Several types |
| | | are supported including: |
| | | Still images |
| | | Motion Clips |
| SOURCE | 850 | The SOURE field is used to |
| | | indicate the file where the |
| | | media representation of the |
| | | advertisement is stored. |
| HYPERLINK | 860 | The HYPERLINK field is used |
| | | to store a web page address |
| | | that the system will direct the |
| | | user to if the user selects the |
| | | advertisement. |
| TOTAL | 870 | The TOTAL REFERELS field |
| REFERALS | | indicates the total number of |
| | | redirections to the advertisers |
| | | web page resulting from user |
| | | selection of the |
| | | advertisement. |

FIG. 12 is a pictorial representation of an advertisement database called Sponsor List. The sponsor list database 880 comprises a plurality of records each of which comprises a plurality of fields. The fields in the advertisement pool database comprise:

User Database-Sponsor List
(880)

| Field Name | Reference | Usage Capacity |
|---|---|---|
| GAME | 890 | The GAME field is a key field |
| | | and is used to identify the |
| | | game a presented by a |
| | | sponsor. |
| CATEGORY | 900 | The CATEGORY field is a key |
| | | field and is used to identify |
| | | one of a plurality of |
| | | advertising categories that the |
| | | sponsor is paying for. |
| SPONSOR | 910 | The SPONSOR field is a key |
| | | field and identifies the party |
| | | paying for the sponsorship. |
| TOTAL | 920 | The TOTAL IMPRESSIONS |
| IMPRESSIONS | | field is used to track the |
| | | number of impressions of the |
| | | advertiser made to |
| | | contestants. |
| TYPE | 930 | The TYPE field indicates the |
| | | media embodiment of the |
| | | advertisement. Several types |
| | | are supported including: |
| | | Still images |
| | | Motion Clips |
| SOURCE | 940 | The SOURE field is used to |
| | | indicate the file where the |
| | | media representation of the |
| | | advertisement is stored. |
| HYPERLINK | 950 | The HYPERLINK field is used |
| | | to store a web page address |
| | | that the system will direct the |
| | | user to if the user selects the |
| | | advertisement. |
| TOTAL | 960 | The TOTAL REFERELS field |
| REFERALS | | indicates the total number of |
| | | redirections to the advertisers |
| | | web page resulting from user |
| | | selection of the |
| | | advertisement. |

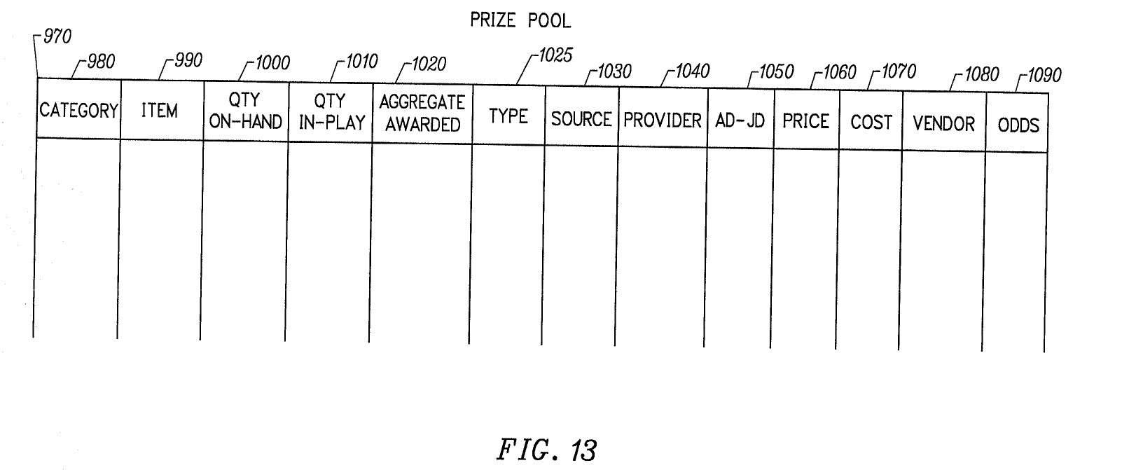

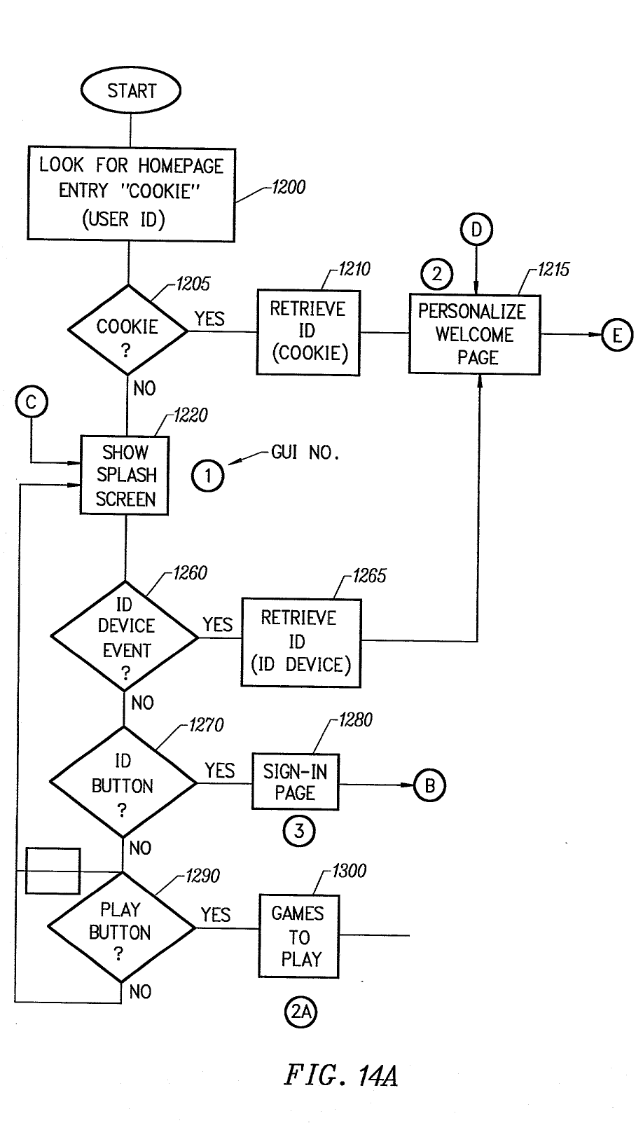

FIG. 13 is a pictorial representation of an advertisement database called Prize Pool. The prize pool database 970 comprises a plurality of records each of which comprises a plurality of fields. The fields in the advertisement pool database comprise:

User Database-Prize Pool
(970)

| Field Name | Reference | Usage Capacity |
|---|---|---|
| CATEGORY | 980 | The CATEGORY field is a key |
| | | field and is used to identify |
| | | category of a prize. |
| ITEM | 990 | The ITEM field is a key field |
| | | and is used to identify a unique |
| | | item within a category of prizes. |
| QTY ON- | 1000 | The QTY ON-HAND field |
| HAND | | indicates the inventory level of |
| | | a product. |
| QTY IN-PLAY | 1010 | The QTY IN-PLAY field is used |
| | | to track the number of the |
| | | particular prize that contestants |
| | | are vying for. |
| AGGREGATE | 1020 | The AGGREGATE AWARDED |
| AWARDED | | field indicates the media |
| | | embodiment of the |
| | | advertisement. Several types |
| | | are supported including: |
| | | Still images |
| | | Motion Clips |
| TYPE | 1025 | The TYPE field indicates the |
| | | media embodiment of the prize |
| | | representation. Several types |
| | | are supported including: |
| | | Still images |
| | | Motion Clips |
| SOURCE | 1030 | The SOURCE field is used to |
| | | indicate the file where the |
| | | media representation of the |
| | | prize is stored. |
| PROVIDER | 1040 | The PROVIDER field is used to |
| | | indicate who is paying for the |
| | | prize or promotion. |
| AD-ID | 1050 | The AD-ID field itself consists |
| | | of a category, advertiser and |
| | | ad-name. These are used as a |
| | | key into the advertisement pool |
| | | data base when the prize is |
| | | affiliated with a particular |
| | | advertisement. |
| PRICE | 1060 | The PRICE field indicates the |
| | | number of contestant points |
| | | that the contestant must |
| | | redeem in exchange for |
| | | receiving the prize. |
| COST | 1070 | The COST field indicates the |
| | | price paid to purchase the item |
| | | from the vendor. |
| VENDOR | 1080 | The VENDOR indicates the |
| | | company that the prize is |
| | | purchased or otherwise |
| | | obtained from. |
| ODDS | 1090 | The ODDS field indicates the |
| | | probability value for winning the |
| | | prize. |

Interface Method

The present invention exploits the ubiquitous web browser interface. By using a web browser on the client device, graphical interfaces can be created and easily modified by using a markup language such as the hyper text markup language (HTML). The present invention adopts the industry nomenclature of a “web page” when referring to graphical user interfaces. Generally, a graphical user interface (GUI), or web page is created using industry standard HTML in conjunction with a Java applets. In the alternative embodiment, GUIs are created using a multimedia-authoring tool.

Access to the databases maintained by the ACS 55 is accomplished by way of SQL requests that are sent to the SQL engine 200. The SQL request are composed by Java scripts attached to web pages introduced infra or by Java applets that comprise the embodiments of games of chance. In either case, the SQL requests are received by the SQL engine 200 and fulfilled. The resulting database activity is reported to the requesting process.

FIG. 14A is the first part of flow diagram that depicts the user interface process employed by the present invention. Whenever a user wants to use the personalized gaming system, the user must specify a gaming system home page using a browser. An analogous process is employed in the slot machine specified herein. The slot machine 75 starts up executing a web browser in a kiosk mode. The kiosk mode dispenses with the presentation of many of the menus ordinarily available to a computer user and presents only a border-less window wherein the composition of a web page is rendered for presentation to the contestant. In the slot machine embodiment, the web browser is immediately directed to the gaming system home page.

Once the home page is loaded into the browser, scripting within the home page attempts to identify the user. In step 1200; the home page script looks for a “cookie” previously written to a non-volatile memory accessible by the user's client device. In the case of a PC, a cookie is normally written to the user's hard disk. If the system finds a cookie (step 1205) the script in the home page will retrieve the identification stored in the cookie (step 1200 to 10). Once the user has been identified, the identification of the user is used to personalize the welcome page presented immediately after the home page script finishes executing (step 1215).

In the event that a cookie is not discovered, the home page will retrieve a universal splash screen and present this to the user (step 1220). The universal splash screen 1225 is normally presented in the slot machine 75 device where the user cannot easily be identified. The splash screen 1225 further comprises a java-script that embodies the logical sequence needed to identify a user in the slot machine 75 of the present invention.

FIG. 14A shows that, after having displayed the splash screen 1225, the slot machine will attempt to identify the contestant. The identification process is embodied as a java-script that calls special web pages served up by a microserver. The microserver is also executing in the slot machine 75 and includes device drivers that work in conjunction with the drivers integral to the operating system. This arrangement enables control of the slot machines physical devices.

The java-scriptattached to the splash screen 1220 waits until there is an identification device event (step 1260). When an identification device event is perceived by the system, the java-scriptwill retrieve the identification number from the device in order to identify the user (step 1265). The java-scriptwill then redirect the web browser to a personal welcome page using the identification number retrieved from the identification device (step 1215). If an identification device event is not immediately sensed, the java-script attached to the splash screen 1225 will continue to wait for an identification device event (step 1260), or for either the identification command button (step 1270) or the play command button (step 1290) to be actuated by the user. In the event that the identification command button is actuated (step 1270) the java-scriptwill direct the web browser to a sign-in page (step 1280). If the java-scriptdetects that the play command button (step 1290) was actuated, the java-scriptwill redirect the web browser to the games-to-play web page (step 1300).

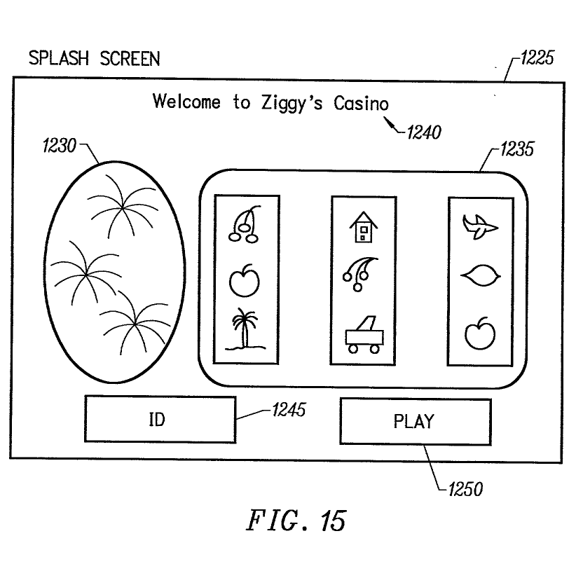

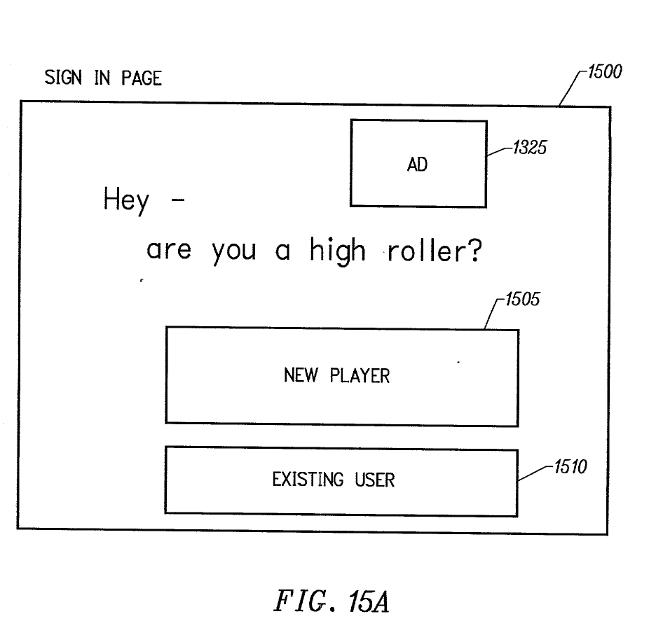

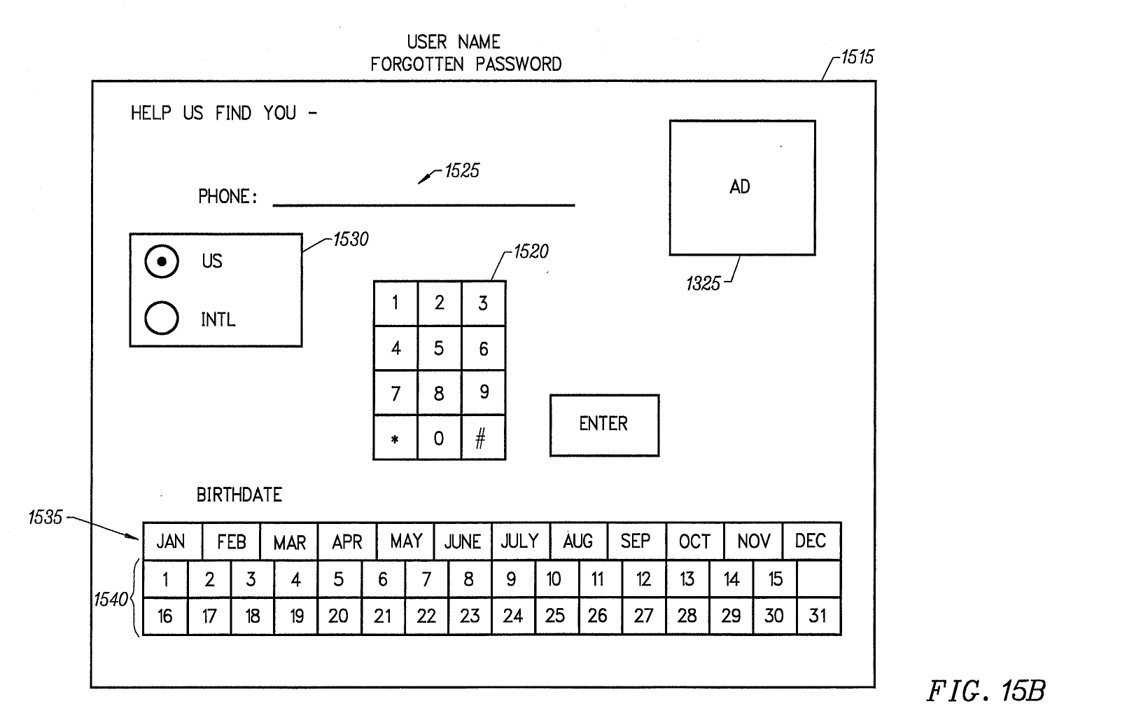

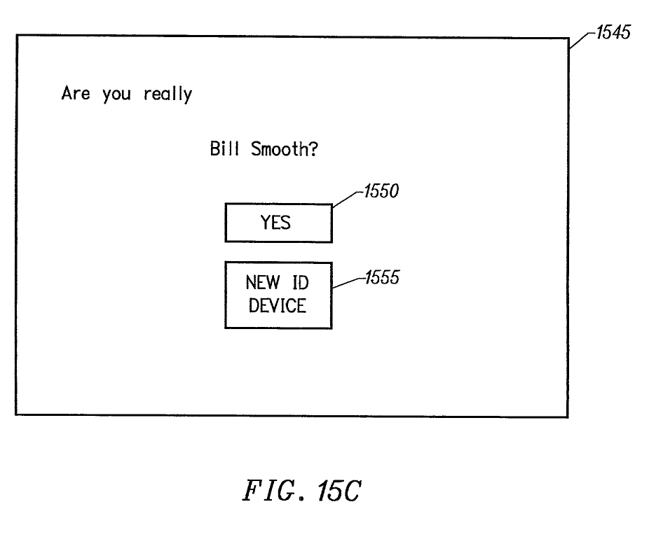

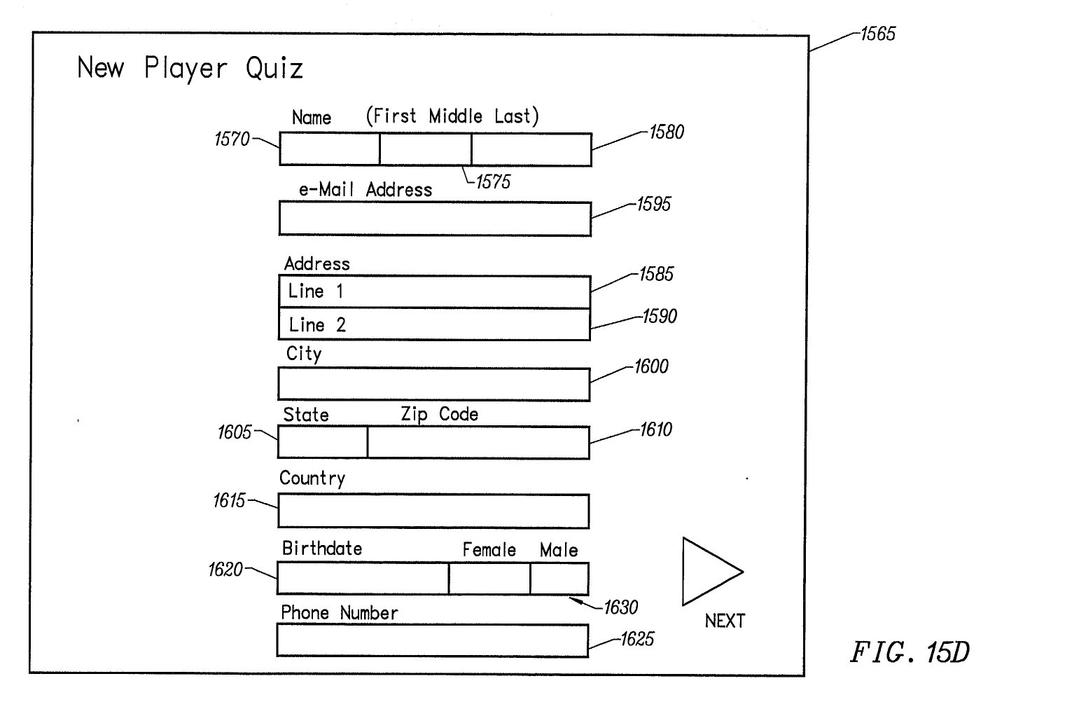

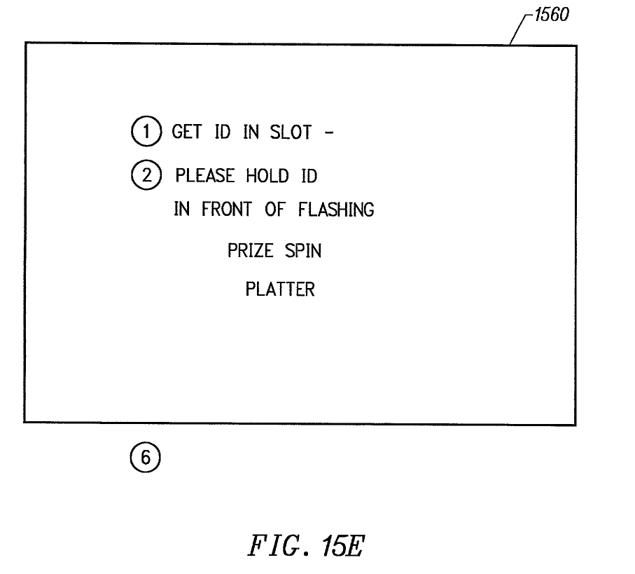

FIG. 15 is a pictorial representation of a typical universal splash screen that is presented on the slot machine of the present invention. The splash screen 1225 comprises attention getting graphics 1230, the emulation of a game a chance: 35, a header 1240, and at least to command buttons. These to command buttons include identification command buttons 1245 and a play command of a 1215. The command buttons comprise hyperlinks to two other web pages as discussed infra.

FIG. 15A is a pictorial representation of a sign-in web page presented to an unknown user. The sign-in web page 1500 comprises an advertisement 1325, instructions on how to use the web page and two command buttons. The two command buttons are: New Player 1505; and Existing User 1510. If the contestant has already registered with the system, the contestant should chose the Existing User command button 1510. Otherwise, the contestant should choose the New Player command button 1505.

FIG. 15B is a pictorial representation of a sign-in web page presented to an existing user. The Existing User command button 1510 hyperlink will direct the browser to the Existing User GUI (web page) 1515. The Existing User web page 1515 comprises an advertisement 1325. The Existing User web page 1515 further comprises a telephone keypad 1520 telephone number display 1525. The Existing User web page 1515 further comprises a US/International radio button control 1530. The contestant is instructed to enter their telephone number using the telephone keypad 1520. The Existing User web page 1515 is java-scriptenabled. The java-scriptreceives one digit of the contestants phone number at a time and echoes the digit in the telephone number display 1525. The contestant is also instructed to indicate if the phone number entered is a US number or an international number. Selecting one of two radio buttons in the US/International radio button control 1530 does this.

Once the contestant has entered a phone number, the system requires that verification of the user be accomplished. This is performed by requiring the contestant to indicate the month of their birth, and optionally the date of their birth. Any means to authenticate the user could be used, including but not limited to asking the user to enter a password. In the present embodiment, the Existing User web page 1515 further comprises radio button controls for month 1535 and date 1540. The contestant must select the month and date of their birth using the month radio button control 1535 and the date radio button control 1540. If the system can not adequately authenticate the user through the above described phone number and birth date mechanism, then the system will prompt the user to try entering the authentication data again.

FIG. 15C is a pictorial representation of a User Validation web page that is presented to a contestant after a manual identification procedure. If the system finds a registered contestant that has been authenticated as described above, then the system will provide the contestant with an opportunity to accept the purported identification. This is accomplished by displaying the contestant's name. Presenting the User Validation web page 1545 does this. The user validation web page 1545 comprises a display of the users name and a Confirmation command button 1550. The User Validation web page 1545 further comprises a New ID Device command button 1555. In the event that the user was found to be registered and now needs a new identification device, the user can select the New ID Device command button 1555. When the user selects the Confirmation command button 1550, the web browser will be directed to the personalized welcome page for the contestant. If the contestant selects the New ID Device command button 1555, then the sign-in process continues by presenting the New ID Device web page 1560 to the user.

FIG. 15D is a pictorial representation of a New Player Questionnaire web page. When the user selects the New Player command button 1505 on the Sign-In web page 1500, the web browser is directed to the New Player Questionnaire web page 1565. The New Player Questionnaire web page 1565 comprises a plurality of data entry controls for each of the following fields:

| Control Name | Reference | Control Type |
|---|---|---|
| First Name | 1570 | Text Entry |
| Middle Name | 1575 | Text Entry |
| Last Name | 1580 | Text Entry |
| Address Line 1 | 1585 | Text Entry |
| Address Line 2 | 1590 | Text Entry |
| e-mail address | 1595 | Text Entry |
| City | 1600 | Text Entry |
| State | 1605 | Drop Down List |
| Postal Code (Zip | 1610 | Text Entry |
| Code) | | |
| Country | 1615 | Drop Down List |
| Birth Date | 1620 | Text Entry |
| Phone number | 1625 | Text Entry |
| Gender | 1630 | Radio Button |

The New Player Questionnaire web page 1565 further comprises a java-scriptthat ensures that all of the text entry controls are properly populated with text. Once the java-scripthas determined that the new user has properly filled out the form, the java-scriptcomposes an SQL request to add a data record to the user list database 220 and to the supplemental information database 350. The data received from the new user is populated into the new records in both databases according the field names corresponding to the acquisition of the information.

FIG. 15E is a pictorial representation of a Program ID Device web page presented to a user after a new identification device is dispensed. The Program ID Device web page 1560 is comprised of textual instructions to the user to place the dispensed identification device in front of a flashing platter on the front surface of the slot machine 75. This is the smart card interface active-area 146. Once the user places the new identification device in front of the active area 146, the slot machine will program the device 160 with the users identification number. This is accomplished through the use of yet another java-scriptattached to the Program ID Device web page 1560. This java-scriptwill call the microserver running locally on the slot machine 75 in order to directly control the hardware devices, i.e. the smart card reader. Once the identification device has been successfully programmed, the web browser is directed to a personalized welcome page for the user.

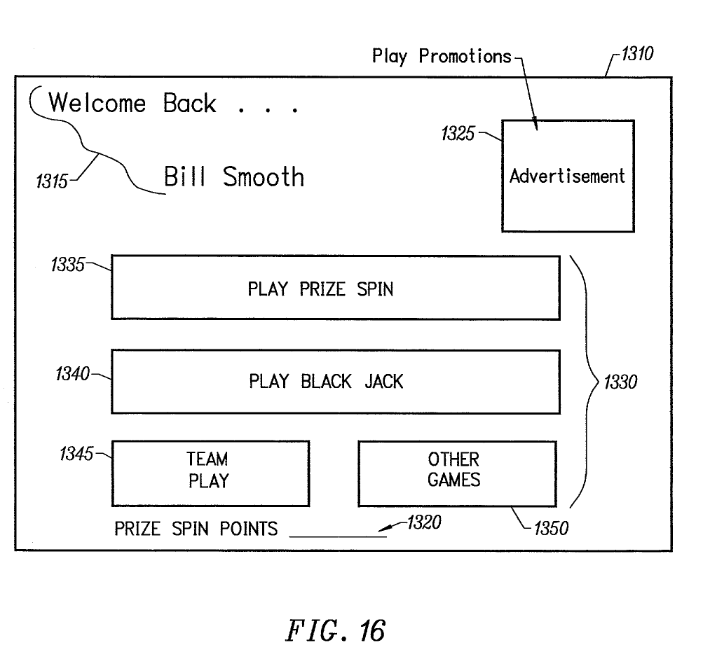

FIG. 16 is a pictorial representation of a personalized welcome page that is presented to a contestant using the system. Using either the cookie identification from a PC 65, Internet appliance 66, or the set-top box 70, or the identification device or a sign-in from a slot machine 75, the identification number 225 of the user is used to access personal information in the user list database 220. The personalized web page 1310 comprises a header that includes the name of the contestant 1315, a display of the number of accumulated points the player has earned so far 1320, a plurality of advertisements 1325 and a plurality of play options 1330.

The name of the contestant is retrieved from the user list database 220 by using the identification number 225 as a key into the table. The user's first and last name are retrieved from those respective fields 240 and 230. The number of points that the contestant has earned is retrieved from the supplemental information database 350, specifically from the points earned field 445.

In the present embodiment, the play options include a preferred game command button 1335 and a secondary preference button 1340. The personalized welcome page 1310 is composed by the ACS 55 based on the user's preferences as recorded in the propensities database 530. One of the propensity categories stored in the propensities database 530 indicates the users two most favorite games of chance. These are used to configure the personalized web page 1310 preferred 1335 and secondary 1340 command buttons. In the case depicted in the figure, the user's first and second preferences are the games called PrizeSpin and Black Jack, respectively. In the event that the contestant wants to engage in team play, a mean to aggregate points with the achievements of other contestant, the contestant can actuate the team play command button 1345. If the contestant would like to play other games, the other games command button 1350 can be selected. These two command buttons direct the web browser to either the team management GUI (web page) 1355 or the games-to-play web page 1360. At this juncture, the contestant can select any one of the command buttons to navigate to the next desired GUI. Any of the advertisements included in the web page further comprise a hyperlink that will direct the web browser to the advertisers web page.

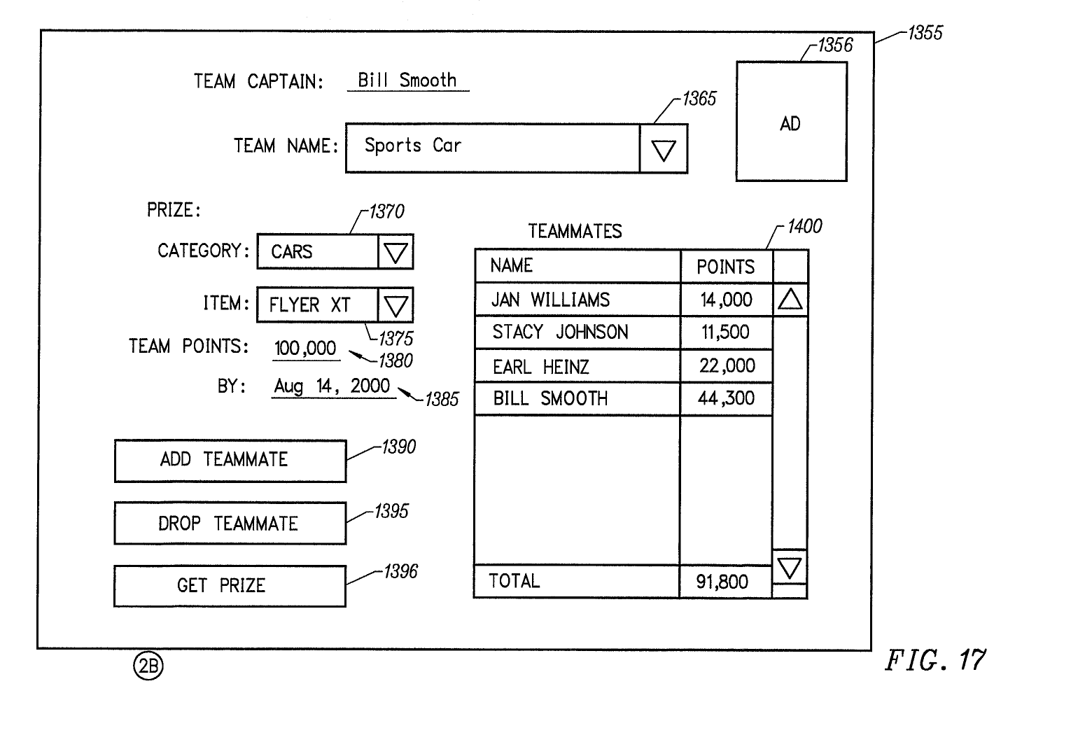

FIG. 17 is a pictorial representation of a Team Management GUI (or web page) according to the present invention. Note that any information shown in the figure is for purposes of illustration only and should not be construed as limiting the scope of the invention. Having selected the team play command button 1345 included in the personalized welcome page 1310, the contestant is presented with a Team Management web page 1355. The Team Management web page 1355 comprises a data display control for presenting the team captain and further comprises a team name control 1365. The team name control 1365 is a drop down list control that can also accept new text input. The ACS 55 will compose the Team Management web page 1355 by first consulting the Teams database 590. Using the current user identification number as a primary key, the ACS 55 will retrieve all of the team names (field 610) from the Teams database 590. This data will be used to populate the team name drop down control 1365.

When the team management web page 1355 is first presented to the contestant, only the team captain and team name controls are initialized. The contestant can then select one of the team names that are included in the team name drop down control 1365. Once the user has selected one of the team names, the java-script attached to the web page will compose an SQL query to retrieve additional information about that team. The SQL query includes, but is not limited to retrieving the category of a prize and the item of a prize (object category field 630 and object item field 630) that the user previously selected as that team's objective, the number of points the team must earn to secure the prize objective (offered price field 640) and the date by which the team must attain the total number of required points (expire date field 650). If the object item is not defined (i.e. a null value is returned in response to the SQL query), then the java-script will populate the item control 1375 with an enumeration of all of the items available in the selected category. This is accomplished by retrieving all of the items defined in the Prize Pool database 970 where the category field 980 is equal to the category value returned from the teams database. If the object has not been previously defined, then the java-scriptwill retrieve a list for all prize categories found in the Prize Pool database 970 and populate the category drop down control 1370 with that enumeration. Once the contestant selects a prize category and item for a team, that selection can not be changed.

The system will determine the total number of points that the team must earn before it can redeem the prize. This is done by retrieving price (in points) of the prize (field 1070) from the prize pool database 970. This price is stored in the teams database 590, offered price field 640. The java-scriptwill retrieve the number of points (teams database 590, offered price field 640) and the expiration date (teams database 590, expire date field 650) of the collaborative objective offer and present these in the two text display controls 1380 and 1385.

The team management web page 1355 further comprises a team mates control 1400. The team mates control 1400 is managed by the java-scriptattached to the web page and is updated whenever a team mate is added or dropped or when the web page is first presented to the contestant. In order to update the team mates control 1400, the java-scriptretrieves a list of all of the team mates affiliated with the team from the team mate database 660. Using the contestants identification number as a primary key (ID number field 670), the java-script composes an SQL query to retrieve all of the team member identification numbers (field member ID 690) for the given team name (team name field 680). The SQL query also retrieves the number of points each team member has earned toward the objective. This information is then presented in the team mates control 1400. The team mates control 1400 is a scrollable text field arranged in a cellular structure.

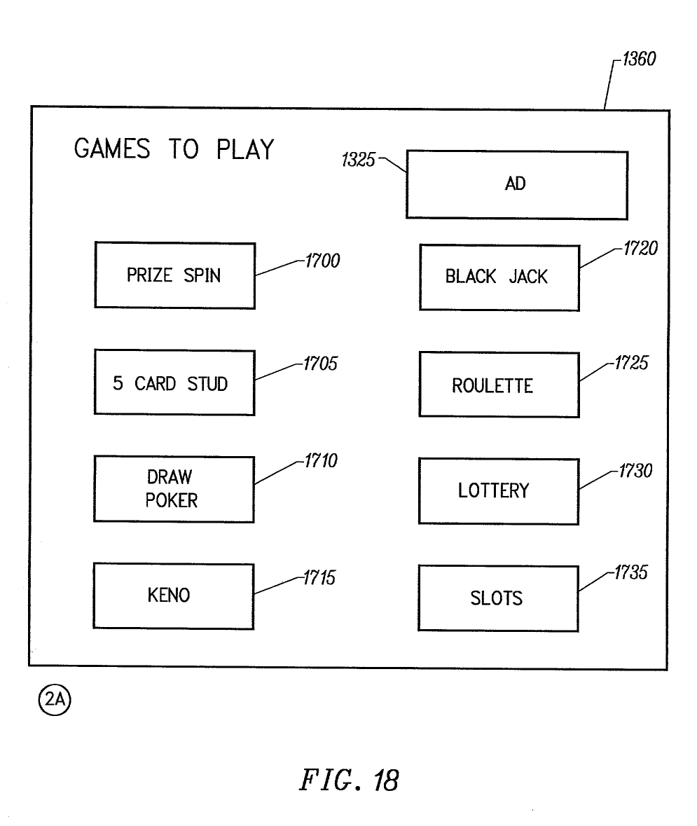

FIG. 18 is a pictorial representation of the games-to-play web page. The games-to-play web page 1360 comprises a plurality of game selection hyperlinks for the PrizeSpin Game 1700, 5-card stud 1705, draw poker 1710, keno 1715, Black Jack 1720, Roulette 1725, Lottery 1730, and Slots 1735. These games are implemented as Java applets attached to web pages referenced by the hyperlinks. When the contestant selects one of the hyperlinks, the browser loads the referenced web page and the Java applet executes.

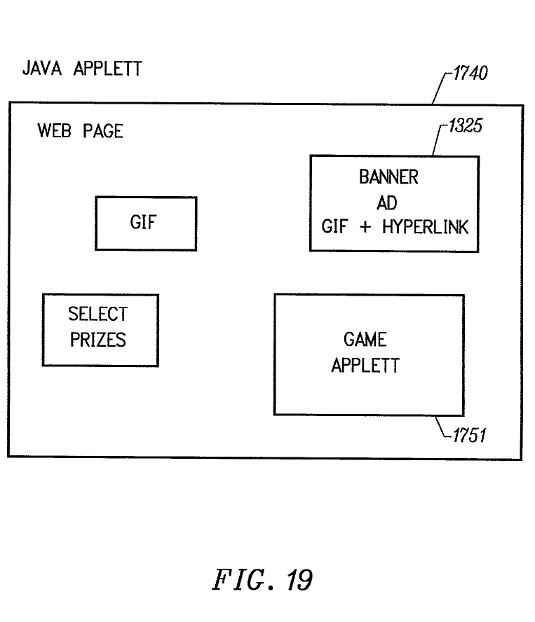

FIG. 19 is a pictorial representation of a gaming web page having at least one Java applet. Gaming web pages 1740 in the system comprise an advertisement 1325 and a game applet 1750. The game applet uses the browser as an execution platform, relying on the browser to accomplish the man-machine-interface.

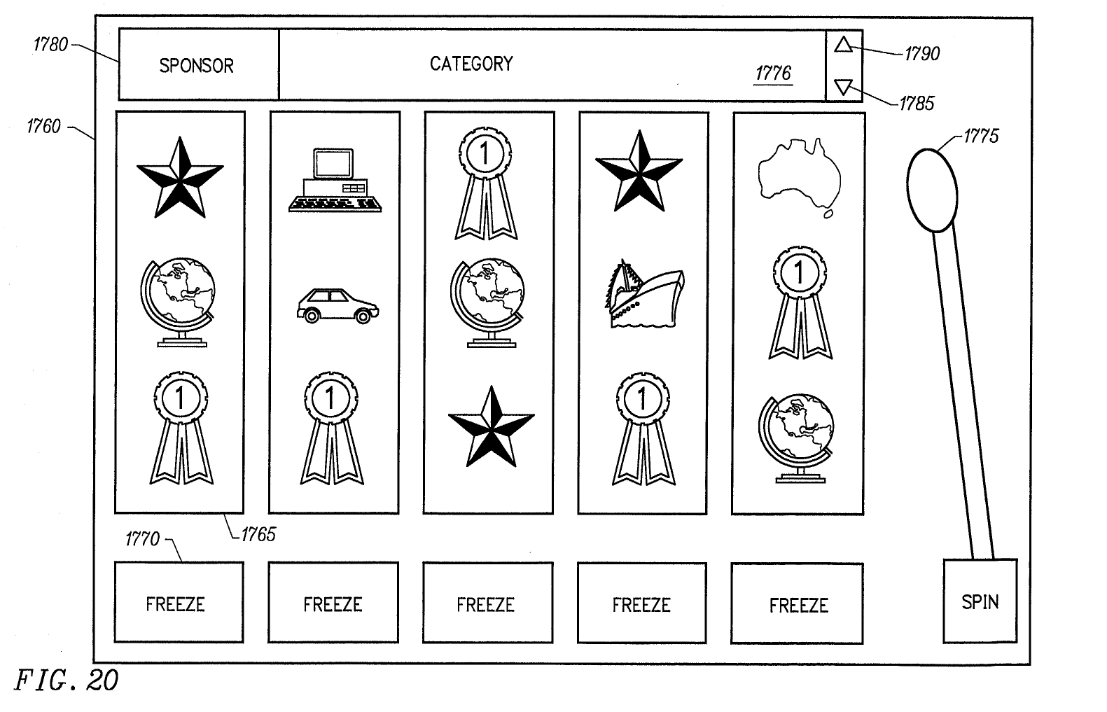

FIG. 20 is a pictorial representation of the graphical user interface presented by the Prize Spin Java applet. The Prize Spin Java applet GUI 1760 comprises a plurality of spin emulators 1765, a corresponding number of freeze command buttons 1770, and a spin command button 1765. The Prize Spin Java applet GUI further comprises a category cylinder 1776, category sponsor window 1780 and category cylinder rotation command buttons back 1785 and forward 1790.

When the Java applet begins executing, the graphical user interface is created and managed directly by the program applet. When a contestant actuates the spin command button 1775, the Java applet will cause the cylinder emulators 1765 to begin scrolling through a series of prize selections. The cylinder emulators will be stopped in sequential order. Before the contestant again spins the cylinders, the contestant can freeze any number of the cylinders to maintain the prize currently portrayed on the cylinder.

Whenever the contestant freezes a prize, the system infers that the contestant is interested in winning that prize. This inference is manifest as an entry in the user propensity database 530. The Java applet creates an SQL request to add a record to the propensity database 530 with the ID number field 540 set to the current contestant identification number and the ordinal field 550 set to the next sequential number. The propensity type field 560 is set to indicate a prize preference propensity and the value field 570 is set to indicate the prize category and item. The date that the event occurred is also stored in the date field 580. A new propensity record is added to the propensity database 530 whenever the contestant freezes a prize. This means that a plurality of propensity records will be created if a contestant chooses to freeze multiple cylinders for the same prize. In the present embodiment, the act of freezing a cylinder will result in a debit of points to the contestant's account. Since freezing a cylinder costs the contestant in terms or points, the inference that the frozen cylinder is important to the contestant can be further sustained.

The cylinder emulator 1765 has another novel utility. Some of the images shown on the cylinder are advertisements. When a cylinder stops scrolling, the Java applet will present the advertisement in a presentation window on the cylinder.

Statistics Gathering

The present invention endeavors to collect statistics by monitoring the contestant's activities. Several mechanisms are employed in the effort to profile a contestant. These mechanisms are described here but can also be summarized as a inferential mechanisms in that the system attempts to profile each contestant based on their behavior during game play.

Favorite Game

As contestants use the system, the system tracks the number of minutes each contestant plays each game of chance. Each game of chance is implemented as a Java applet. That Java applet will note the time at which the contestant started playing the game. When the contestant stops playing the game, the Java applet will again read the time of day and subtract the start time from the end time. This difference will be accumulated to the users play preference. This accumulation is accomplished by composing an SQL request to create a new record in the user statistics database 450. The new record is then populated with the next sequential ordinal number (ordinal field 470) and the type 480 and subtype 490 fields set to indicate the type of game being played. The value field 500 is set with the total number of minutes played and the record date 510 is also recorded. Whenever the contestant returns to the system, the statistics database 450 is consulted and all records having the users identification number and that have game play information are extracted from the database by the web server executing in ACS 55. The ACS 55 will then determine what the contestants two favorite games are when a personalized welcome page is created for the user.

Prize Preference

The present invention further comprises a collection of games that are implemented as Java applets. These Java applets are attached to web pages that are loaded by the client side browser upon selection of that game by the contestant. When a contestant plays any game of chance in the system, the Java applet will send propensity records to the ACS 55 in order to record product preferences or spending propensities of that contestant.

As the player plays any of the games offered by the system, the game applet will retrieve personal attributes about the contestant from the user list database 220, from the user supplemental database 350 and from the user propensities database 530 using an SQL query. When a game applet offers a plurality of prizes that the contestant can win, prizes are selected from the prize pool database 970 based on either personal attributes or a correlation of certain propensities the player is exhibiting to the prize categories.

The prize pool database 970 may have a plurality of categories including, but not limited to:

Product Categories:

Furniture

Consumer Electronics

Books

Computers

Cars

Sporting Goods

Baby Wares

Hobby Supplies

Promotion Categories:

Entertainment

Sports

Fitness

Travel

Home

Lifestyle Categories:

Family Bent

Senior Citizen

Teenager

City Dweller

New Yorker

Traveler

Because some prizes will be appealing to more than one category, a prize record may be duplicated in the prize pool database 970 so that the identical prize item will appear in more than one category.

Prize categories are selected based on the personal attributes or based on propensities. As users play a game, their propensities will be updated according to their game play activity. A propensity record will be appended to the propensity database 530.

Advertisements

FIG. 11 shows that when an advertisement is sold to an advertiser, a record in stored in the advertisement pool database 770. Advertisements are sold to companies or individuals that want to present a multi-media message to the contestants using the system. Each advertisement is stored according to a product category. The category is recorded in the category field 780 of the advertisement pool database 770. The current embodiment has a plurality of categories, including, but not limited to:

Entertainment;

Sports;

Fitness;

Travel; and

Home.

Each advertisement record is stored with the name of the advertiser in field 790 and the name of the advertisement 800. The negotiated cost of presenting the advertisement to contestants is also stored in the cost per thousands (CPM) field 810. The saturation level of the advertisement is stored in the field of the same name 820. The saturation level is a multiplier that results in preferential presentation among advertisements in a category. Advertisements with a greater saturation level value will be presented more frequently than those with a smaller saturation value.

As the advertisement is presented to users, the system will keep track of the number of impressions of the advertisement that are presented. This is done directly by the ACS 55 when web pages are composed. Advertisements can be in many different forms, as an illustrative example, advertisements can be simple graphic images, animated graphics, interactive multimedia presentations, audio or video clips. The advertisement pool database 770 stores a reference to a source file (field 850) for the advertisement. An appropriate companion, extension or plug-in is used in conjunction with the browser in order to display an advertisement.

Advertisements are also presented by the Java applets that embody the plurality of games of chance that the contestants can play. In the event that a Java applet needs to present an advertisement, the applet will send a request to the ACS 55 to retrieve a reference to an advertisement. Once the applet receives the reference, it retrieves the source file from the ACS 55 and then displays the advertisement to the contestant. When the ACS 55 provides a reference to a Java applet, it increments the impression counter (field 830) for that advertisement.

The present invention presents advertisements in accordance with preferences attributed to each individual contestant. As disclosed earlier, each contestant using the system is profiled. The propensities database is processed on a period basis, currently one week but the period is adjustable as needs dictate. The processing of the propensity database 530 comprises the extraction of any products that the contestant favors over the proceeding plurality of processing periods. The resulting list of products is then sorted by product category and the resulting categories are again stored in the propensities database 530.

When the system needs to present an advertisement, the preferences for product categories are retrieved from the propensities database 530 and an advertisement is selected from the advertisement pool database 770 in a random manner having a matching category. Of course, where there are a plurality of advertisements in a category, the selection is weighted according to the saturation level (field 820) for each of the advertisements.

Sponsorships

Many of the games of chance that are presented in the system are sponsored. Sponsorships are, in essence, super ads. These super ads are presented to the contestant for the duration of game play and are categorized.

FIG. 20 is an excellent illustration of a sponsorship in the Prize Spin game. A plurality of sponsorships can be sold to companies is a plurality of product categories. A sponsor presentation window 1780 is visible so long as the contestant remains in the corresponding category. In the prize spin game, the contestant can change categories using the category forward 1790 and back 1785 command buttons.

As is the case with any advertisement, a sponsorship message can be in any multimedia form supported by the system.

Hyperlink Processing

The system charges additional fees for referring a contestant to an advertisers or sponsors web site. Every advertisement presented to a contestant by the system, including sponsorship, is in the form of:

www.acs.com/ad_reference=ref_address,userID

This hyperlink first causes a special referral page to be loaded. The referral page is called “reference”. The actual address of the advertisers web page is passed to the referral page as an argument. The referral page has an attached java-scriptthat uses the web page address to as an indicator that the corresponding advertiser should be charged for a referral. This is recorded by incrementing the referral field 870 of the advertisement pool database. Optionally, the system can use the userlD to record the contestant that requested the referral.

In the event that the advertisement is a sponsorship presentation, the form of the hyperlink is:

www.acs.com/spon_reference=ref_address,userlD

This hyperlink is processed analogously to that of an advertisement reference. The difference between the <ad_reference> and <spon_reference> lies in the JavaScripts attached to each. In the advertisement referral page, the java-scriptcounts references by incrementing the referral counter in the advertisement pool database 770. The sponsorship referral page increments the total impressions field 920 in the sponsor list database 880. These incrementing activities are implemented as SQL commands that each respective java-scriptcomposes and directs to the ACS 55.

Prize Fulfillment

The present invention establishes a probability level for the awarding prizes and or points. The odds that a particular prize will be awarded directly by a game-of-chance is established by monitoring the number of contestants vying for the prize. The odds of wining a prize are also based on the number of advertising impressions that must be presented in order to ensure overall profitability for the system operator.

In the present embodiment, the odds of winning a prize are first calculated as a function of:

the cost of the prize stored in the prize pool database 970 cost field 1070; and

minimum of all advertisement cost per thousand that have the prize indicated as the correlated item in the advertisement pool database 770, field 785.

The first imperative in setting odds of winning is that the difference in the cost the prize must be less than the amount of revenue received as a result of advertising revenue.

A contestant can receive prizes either by winning the prize at the calculated probability, or the contestant can redeem points won or purchased toward the prize.

Marketing Data

Many advertisers and sponsors will want to purchase marketing data directly from the system operator. Marketing data is tracked for every contestant registered in the user list database 220. The marketing data is stored in the propensities database 530. On a periodic basis, the period of which is definable to the system operator, the billing server 56 will retrieve the user list database 220 and the propensities database 530 and store copies of these databases in the billing server. The billing server will then create a report of buying propensities that describes the interest level of each contestant in product categories and specific prizes and/or promotions. This report will be e-mailed to a purchaser using an electronic shopping facility. The electronic shopping facility will then print an invoice using as printer 57 or it will debit the purchasers account using a special electronic fund transfer interface 58.

Contestant Billing

Contestants compete in play using points. Points must be purchased before a player can play a game of chance. A billing GUI requires the contestant to enter a credit card number, expiration date and the name on the card. This information is stored in the user supplemental information database 350, the credit card field 430. As points are purchased, the number of points available for that contestant is adjusted accordingly. The number of points available is also stored in the user supplemental information database 350. The points available are stored in a field with the same name 435. The billing server 56 will use the special transaction interface 58 to obtain credit card authorization from the issuing bank.

Promoter Billing

The system adheres to a monthly billing cycle for advertisers and sponsors, although the billing period can be adjusted to suit the needs to the system operator. Upon initiation, the billing server (FIG. 2: 56) will make a copy of all of the databases involved in billing. These include, but not necessarily are limited to:

advertisement database 770; and

o sponsor list database 880.

At the end of the billing cycle, the billing databases are again copied from the ACS 55 into a separate set of files in the billing server 56. The copies retained by the billing server 56 as the end of a billing cycle will become the initial databases for the subsequent billing cycle.

Once the databases are copied, the billing server 56 will discover any differences in the total impression count and the referral count for each advertiser and sponsor. These differences will be the basis for billing the advertisers and sponsors for presenting their multimedia messages. Billing can be accomplished either by printing invoices using a printer 57 or by conducting electronic debit transactions to the advertisers or sponsors bank account using a special interface 58.

The final step in the billing cycle is to determine which advertisements and sponsorships have expired. This is done with the aid of an off-line database. The billing server 56 will then compose an SQL command to remove the records for each of the expired advertisements and sponsorships from the working billing databases maintained in the ACS 55.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternatives are described herein.

The invention uses an SQL database engine and allows remote devices to interact with the databases using the structured query language. Any other suitable database management system that allows clients to interact with a main set of databases is sufficient to support the database needs of the present invention.

The invention employs a standard web browser that can present HTML web pages and execute java-scriptand Java applets. Other possible embodiments would include a custom web GUI definition language and psudo code executive. One such other implementation would be a multimedia presentation created in MacroMedia™ Flash™ MPEG-4 technology could likewise be utilized.

The invention is based on TCP/IP protocols. Other alternative, including the use of isochronous channels to carry multimedia to the client devices and asymmetrical protocols could also be used. Any suitable networking structure that provides for client sever interaction is an acceptable alternative to TCP/IP.

The invention is based on client device connected to computer network. Wireless devices such as PDA's and cell phones interface with slot machines to identify the contestant and then effect any financial transactions the contestant authorizes. Other alternatives include using wireless devices with other client devices such as a personal computer, a set-top box and a ubiquitous Internet appliance. Each client device contains a wireless network interface. The wireless network interface uses low-power radio-frequency communications to communicate with personal electronic devices such as PDA's and cell phones.

The wireless network interface incorporated into the invention uses a frequency-hopping scheme in conjunction with an encryption mechanism that supports secure transactions. The wireless network interface of the present invention conforms to the Bluetooth specification adopted by an industry consortium. It should be noted that any suitable wireless network interface can be utilized so long as secure transactions, wireless transactions with small personal devices can be accommodated. When a contestant first approaches the client device, the wireless network interface establishes a connection with the contestant's personal device. This connection allows the client device to identify the contestant and then effect any financial transactions the contestant authorizes.

The invention is based on a PGS wired to client devices. Another preferred embodiment includes the use of wireless communication devices employing wireless protocols to connect the client devices to the PGS. Monies are transferred to and from the PGS and the client devices. Transactions are secured using the Bluetooth specification as described previously.

1. A method for presenting advertisements to a user comprising the steps of:
receiving personal information about the user;
providing a game for the user to play;
selecting an advertisement from a pool of advertisements according to said personal information;
integrating said advertisement into the game;
wherein said game is accessed by client devices comprising any of:
a personal computer, a set-top box, a ubiquitous Internet appliance and a slot machine.

2. The method of claim 1 further comprising the steps of:
allowing the player to select preferences for prizes;
monitoring the players preference selections; and
updating said personal information to reflect said preference selections.

3. The method of claim 1 further comprising the steps of:
allowing the user to activate an advertisement during the course of its presentation;
retrieving additional information for the activated advertisement; and
presenting said additional information to the user.

4. The method of claim 3 wherein the additional information is in the form of a graphic image.

5. The method of claim 3 wherein the additional information is in the form of an animated graphic image.

6. The method of claim 3 wherein the additional information is in the form of a video clip.

7. The method of claim 3 wherein the additional information is in the form of an interactive multimedia presentation.

8. The method of claim 3 wherein the additional information is in the form of an audio clip.

9. A method for presenting advertisements to a user comprising the steps of:
providing a game for the user to play;
selecting an advertisement from a pool of advertisements according to a set of propensities describing the user;
integrating said advertisement into the game;
wherein said game is accessed by client devices comprising any of:
a personal computer, a set-top box, a ubiquitous Internet appliance and a slot machine.

10. The method of claim 9 further comprising the steps of:
allowing the player to select preferences for prizes;
monitoring the players preference selections; and
updating said propensities to reflect said preference selections.

11. The method of claim 9 further comprising the steps of:
allowing the user to activate an advertisement during the course of its presentation;
retrieving additional information for the activated advertisement; and
presenting said additional information to the user.

12. The method of claim 11 wherein the additional information is in the form of a graphic image.

13. The method of claim 11 wherein the additional information is in the form of an animated graphic image.

14. The method of claim 11 wherein the additional information is in the form of a video clip.

15. The method of claim 11 wherein the additional information is in the form of an interactive multimedia presentation.

16. The method of claim 11 wherein the additional information is in the form of an audio clip.

17. A method for selecting prizes that a user can win in a game comprising the steps of:
allowing the user to play a game;
monitoring the users activity during game play to determine if the user is exhibiting a preference for a particular prize;
presenting prizes that the user can win by playing said game wherein the prizes are selected based on a set of propensities exhibited by the user;
updating said set of propensities to reflect said exhibited prize preference.; and
wherein said game is accessed by client devices comprising any of:
a personal computer, a set-top box, a ubiquitous Internet appliance and a slot machine.

18. A method for selecting prizes that a user can win in a game comprising the steps of:
receiving a plurality of personal attributes describing a user;
selecting a prize based on a subset of the said plurality of attributes; and
wherein said game is accessed by client devices comprising any of:
a personal computer, a set-top box, a ubiquitous Internet appliance and a slot machine.

19. A method for selecting prizes that a user can win in a game comprising the steps of:
receiving a plurality of personal attributes describing a user;
segregating a collection of prizes into a plurality of categories;
selecting one of said categories based on a first personal attribute of the user;
selecting a prize from said selected category based on a second personal attribute of the user; and
wherein said game is accessed by client devices comprising any of:
a personal computer, a set-top box, a ubiquitous Internet appliance and a slot machine.

20. A method for selecting prizes that a user can win in a game comprising the steps of:
presenting an enumeration of prizes that the user can win;
receiving from the user a selection of a prize presented in the enumeration; and
wherein said game is accessed by client devices comprising any of:
a personal computer, a set-top box, a ubiquitous Internet appliance and a slot machine.

21. A method for determining what prizes are of more interest to a contestant comprising the steps of:
establishing an account for a contestant;
presenting a plurality of prizes that the contestant can win;
allowing the contestant to select a prize that the contestant wants to win;
allowing the contestant to engage a random process to determine if the prize should be awarded in exchange for a debit of a first quantity of points from said account;
allowing the contestant to improve the likelihood of winning in exchange for a second quantity of points from said account;
recording the prize selected by the contestant;
counting the number of times that the contestant engages said random process; and
counting the number of times that the contestant improves the odd that thecontestant.

22. A method for awarding prizes to a contestant comprising the steps of:
offering to a contestant a plurality of prizes that the contestant can win;
tracking the cost of each of said plurality of prizes;
associating an advertisement with each of said prizes;
tracking the income received for each impression of the advertisement presented to the contestant; and
adjusting a probability that the contestant will win the prize so as to ensure that the income received for all impressions of the advertisement over a period of time exceeds the cost of the prize.

23. The method of claim 22 further comprising the steps of:
allowing the contestant to engage a random process with said adjusted probability to determine if the prize is to be awarded; and
allowing the contestant to print a coupon that can be used to redeem the prize after it is awarded.

24. An advertisement presentation unit comprising:
database of personal information describing a plurality of attributes for a plurality of users;
attribute reception interface;
database manager that receives attributes from the attribute reception unit and stores said attributes in said database of personal information;
advertisement database comprising fields for a category for each advertisement record;
advertisement reception unit that receives advertisements together with a category label and stores the advertisements together with their category labels in said advertisement database;
orrelation unit that receives an input that specifies one user and retrieves a personal attribute for that user from the database of personal information and reads a correlation category from a table using the retrieved personal attribute as an index;
selection unit that receives the correlation category and retrieves an advertisement from said advertisement database where the category label of the advertisement retrieved matches the correlation category; and
advertisement delivery unit capable of delivering the advertisement to a game.

25. The advertisement presentation unit of claim 24 further comprising a computer game that:
receives advertisements from said advertisement delivery unit and presents them to a user;
allows players to win prizes;
allows players to select what prizes they want to win;
records the players selection activities; and
updates the personal information about a user stored in the database of personal information.

26. The advertisement presentation unit of claim 25 further comprising:
monitoring unit that receives activation requests from a user together with an indication of what advertisement was activated;
information retrireview unit that receives an indication of what advertisement was activated by the user from the monitoring unit and retrieves additional information about the advertisement; and
multimedia presentation unit that retrieves additional information attached to an advertisement from the information retrireview unit and presents said information to a user.

27. The advertisement presentation unit of claim 26 wherein the additional information is in the form of a graphic image.

28. The advertisement presentation unit of claim 26 wherein the additional information is in the form of an animated graphic image.

29. The advertisement presentation unit of claim 26 wherein the additional information is in the form of a video clip.

30. The advertisement presentation unit of claim 26 wherein the additional information is in the form of an interactive multimedia presentation.

31. The advertisement presentation unit of claim 26 wherein the additional information is in the form of an audio clip.

32. An advertisement presentation unit comprising:
database of personal propensities describing a plurality of attributes for a plurality of users;
advertisement database comprising fields for a category for each advertisement record;
advertisement reception unit that receives advertisements together with a category label and stores the advertisements together with their category labels in said advertisement database;
correlation unit that receives an input that specifies one user and retrieves a personal propensities for that user from the database of personal propensities and reads a correlation category from a table using the retrieved personal attribute as an index;
selection unit that receives the correlation category and retrieves an advertisement from said advertisement database where the category label of the advertisement retrieved matches the correlation category; and
advertisement delivery unit capable of delivering the advertisement to a game.

33. The advertisement presentation unit of claim 32 further comprising a computer game that:
receives advertisements from said advertisement delivery unit and present them to a user;
allows players to win prizes;
allows players to select what prizes they want to win;
records the players selection activities; and
updates the personal propensities about a user stored in the database of personal propensities.

34. The advertisement presentation unit of claim 33 further comprising:
monitoring unit that receives activation requests from a user together with an indication of what advertisement was activated;
information retrireview unit that receives an indication of what advertisement was activated by the user from the monitoring unit and retrieves additional information about the advertisement; and
multimedia presentation unit that retrieves additional information attached to an advertisement from the information retrireview unit and presents said information to a user.

35. The advertisement presentation unit of claim 34 wherein the additional information is in the form of a graphic image.

36. The advertisement presentation unit of claim 34 wherein the additional information is in the form of an animated graphic image.

37. The advertisement presentation unit of claim 34 wherein the additional information is in the form of a video clip.

38. The advertisement presentation unit of claim 34, wherein the additional information is in the form of an interactive multimedia presentation.

39. The advertisement presentation unit of claim 34, wherein the additional information is in the form of an audio clip.

40. A prize selection unit comprising:
database of available prizes containing a plurality of prize descriptions;
database of personal information containing a plurality or attributes for a plurality of users;
attribute reception unit that receives a plurality of attributes for a plurality of users and stores said received attributes in the database of personal information; and
selection unit that:
receives an identification of a user and an indicator of required selection attributes;
retrieves the required selection attributes from the database of personal information for the identified user; and
selects a prize that matches the retrieved selection attributes from the database of available prizes.

41. A prize selection unit comprising:
database of available prizes containing a plurality of prize descriptions that are segregated into categories;
database of personal information containing a plurality or attributes for a plurality of users;
attribute reception unit that receives a plurality of attributes for a plurality of users and stores said received attributes in the database of personal information; and
selection unit that:
receives an identification of a user and an indicator of a first and second required selection attributes;
retrieves the first and second required selection attributes from the database of personal information for the identified user; and
selects a prize category that matches the retrieved selection attribute from the database of available prizes.

42. A prize selection unit comprising:
database of personal propensities;
monitoring unit that detects selection request from a user and issues an enumeration request;
presentation module that presents an enumeration of available prizes to the user upon receiving an enumeration request; and
selection module that receives from a user a plurality prize selections and stores the selections received in said database of personal propensities.

43. A prize interest quotient acquisition device comprising:
database of personal propensities;
account register that stores the balance of points that a user has;
prize presentation unit that presents a user with a selection of prizes that can be won;
prize selection unit that receives from the user a indication of what prize is to be played for and stores this indication in the database of personal propensities; and
contest unit that:
receives an indication from a user to engage a random process to determine if the prize is won, decrements the value stored in the account register by a first quantity of points and then stores the indication of random process together with the prize selection in the database of personal propensities; and
receives an indication from a user that the probability of winning the prize is to be enhanced, decrements the value stored in the account register by a second quantity of points and then stores the indication of probability enhancement together with the prize selection in the database of personal propensities.

44. A prize fulfillment unit comprising:
database of a plurality of advertisements available for presentation that comprises an income value for each impression of each of the plurality of advertisement;
database of a plurality of prizes available for award to a contestant that comprises a cost value for each prize and an indicator that associates each prize with an advertisement; and
cost correlator that:
receives a request from a game for a probability indicator for a selected prize;
uses the indicator of the selected prize as an index to retrieve the cost of the prize from the database of a plurality of prizes;
retrieves from the database of a plurality of advertisements the income value for the advertisement that has an indicator that associates that advertisement with the indicator of the selected prize;
calculates the number of impressions that are required to result in income greater than the cost of the selected prize; and
issues a probability indicator that is based on said calculated number of impressions required and the cost of the selected prize.

45. The prize fulfillment unit of claim 44, further comprising:
random number generator that accepts a probability indicator issued by the cost correlator and determines if the selected prize is to be awarded; and
coupon generator that creates a coupon that can be printed by the user and can be used to redeem the prize.

46. The method of claim 45 wherein said client devices are interfaced with wireless devices comprising any of:
a personal digital assistant and a cellular phone.

47. The method of claim 46 wherein said wireless device is used to identify said user and perform financial transactions.

48. The method of claim 45, wherein said game is accessed by said client devices using a wireless means.

49. The prize selection unit of claim 24, wherein said game is accessed by client devices comprising any of:
a personal computer, a set-top box, a ubiquitous Internet appliance, and a slot machine.

50. The prize selection unit of claim 49, wherein said client devices are interfaced with wireless devices comprising any of:
a personal digital assistant and a cellular phone.

51. The prize selection unit of claim 50, wherein said wireless device is used to identify said user and perform financial transactions.

52. The prize selection unit of claim 49, wherein said game is accessed by said client devices using a wireless means.

53. The advertisement presentation unit of claim 32, wherein said game is accessed by client devices comprising any of:
a personal computer, a set-top box, a ubiquitous Internet appliance, and a slot machine.

54. The advertisement presentation unit of claim 53, wherein said client devices are interfaced with wireless devices comprising any of:
a personal digital assistant and a cellular phone.

55. The advertisement presentation unit of claim 54, wherein said wireless device is used to identify said user and perform financial transactions.

56. The advertisement presentation unit of claim 55, wherein said game is accessed by said client devices using a wireless means.

57. The prize fulfillment unit of claim 44, wherein said game is accessed by client devices comprising any of:
a personal computer, a set-top box, a ubiquitous Internet appliance, and a slot machine.

58. The prize fulfillment unit of claim 57, wherein said client devices are interfaced with wireless devices comprising any of:
a personal digital assistant and a cellular phone.

59. The prize fulfillment unit of claim 58, wherein said wireless device is used to identify said user and perform financial transactions.

60. The prize fulfillment unit of claim 59, wherein said game is accessed by said client devices using a wireless means.

61. The method of claim 21, wherein said contestant increases or decreases said points in said account based upon the outcome of a game.

62. The method of claim 61, wherein said game is a game of chance.

63. The method of claim 62, wherein said game of chance comprises any of:
slots, blackjack, poker, roulette and lottery.

64. The method of claim 18, wherein said game is selected based on said subset of the said plurality of attributes.

65. The prize interest quotient acquisition device of claim 43, wherein said contestant increases or decreases said points in said account based upon the outcome of a game.

66. The prize interest quotient acquisition device of claim 65, wherein said game is a game of chance.

67. The prize interest quotient acquisition device of claim 66, wherein said game of chance comprises any of:
slots, blackjack, poker, roulette and lottery.

68. The prize selection unit of claim 40, wherein a game is played allowing said user to earn said prizes and wherein said game is selected based on said plurality of attributes.
